(19) United States
(12) Patent Application Publication
(10) Pub. No.: US 2012/0163473 A1
(43) Pub. Date: Jun. 28, 2012

(54) METHOD FOR ENCODING A VIDEO SEQUENCE AND ASSOCIATED ENCODING DEVICE

(75) Inventors: GUILLAUME LAROCHE, Rennes (FR); PATRICE ONNO, Rennes (FR); CHRISTOPHE GISQUET, Rennes (FR)

(73) Assignee: CANON KABUSHIKI KAISHA, Tokyo (JP)

(21) Appl. No.: 13/333,472

(22) Filed: Dec. 21, 2011

(30) Foreign Application Priority Data
Dec. 24, 2010 (GB) 1021976.4
Jun. 29, 2011 (GB) 1111065.7

(51) Int. Cl. H04N 7/68; H04N 7/26

(52) U.S. Cl. 375/240.24; 375/E07.2; 375/E07.281

(57) ABSTRACT

The invention relates to encoding a video sequence. A method according to the invention comprises encoding a first image; generating two reconstructions from the encoded first image, using two different reconstruction offsets; encoding a second image using temporal prediction based on a reference image selected from a set comprising the two reconstructions; wherein the obtaining of a different reconstruction offset comprises: partitioning the encoded first image to select the blocks of one partition, for example using criteria based on CTB, PU, TU of the HEVC standard or the Skip mode; for several reconstruction offsets, estimating a distortion measure based only on blocks collocated with those selected blocks, between the first reconstruction and an image reconstruction of the first image using each offset; and selecting the offset associated with minimum distortion.

This application claims priority from GB patent application No. 10 21976.4 of Dec. 24, 2010 and from GB patent application No. 11 11065.7 of Jun. 29, 2011 which are incorporated herein by reference.

### FIELD OF THE INVENTION

The present invention concerns a method for encoding a video sequence, and an associated encoding device.

### BACKGROUND OF THE INVENTION

Video compression algorithms, such as those standardized by the standardization organizations ITU, ISO, and SMPTE, exploit the spatial and temporal redundancies of images in order to generate bitstreams of data of smaller size than original video sequences. Such compressions make the transmission and/or the storage of video sequences more efficient.

FIGS. 1 and 2 respectively represent the scheme for a conventional video encoder 10 and the scheme for a conventional video decoder 20 in accordance with the video compression standard H.264/MPEG-4 AVC (“Advanced Video Coding”).

The latter is the result of the collaboration between the “Video Coding Expert Group” (VCEG) of the ITU and the “Moving Picture Experts Group” (MPEG) of the ISO, in particular in the form of a publication “Advanced Video Coding for Generic Audiovisual Services” (March 2005).

More advanced standards are being developed by VCEG and MPEG. In particular, the standard of next generation to replace the H.264/MPEG-4 AVC standard is still being drafted and is known as the HEVC standard (standing for “High Efficiency Video Coding”).

This HEVC standard introduces new coding tools and new coding entities that are generalizations of the coding entities defined in H.264/AVC, as further described below. Although the HEVC standard is continuously changing, its core idea on which the present invention is based remains and still applies.

FIG. 1 schematically represents a scheme for a video encoder 10 of H.264/AVC type or of one of its predecessors.

The original video sequence 101 is a succession of digital images “images i”. As is known per se, a digital image is represented by one or more matrices of which the coefficients represent pixels.

The value of a pixel can in particular correspond to luminance information. In the case where several components are associated with each pixel (for example red-green-blue components or luminance-chrominance components), each of these components can be processed separately.

According to the H.264/AVC standard, the images are cut up into “slices”. A “slice” is a part of the image or the whole image. These slices are divided into macroblocks, generally blocks of size 16 pixels×16 pixels, and each macroblock may in turn be divided into different sizes of data blocks 102, for example 4×4, 4×8, 8×4, 8×8, 8×16, 16×8. The macroblock is usually the coding unit in the H.264 standard.

During video compression, each block of an image is predicted spatially by an “Intra” predictor 103, or temporally by an “Inter” predictor 105. Each predictor is a set of pixels of the same size as the block to be predicted, not necessarily aligned on the grid decomposing the image into blocks, and is taken from the same image or another image. From this set of pixels (also hereinafter referred to as “predictor” or “predictor block”) and from the block to be predicted, a difference block (or “residual”) is derived. Identification of the predictor block and coding of the residual make it possible to reduce the quantity of information to be actually encoded.

It should be noted that, in certain cases, the predictor block can be chosen in an interpolated version of the reference image in order to reduce the prediction differences and therefore improve the compression in certain cases.

In the “Intra” prediction module 103, the current block is predicted by means of an “Intra” predictor, a block of pixels constructed from information on the current image already encoded.

With regard to “Inter” coding by temporal prediction, a motion estimation 104 between the current block and reference images 116 (past or future) is performed in order to identify, in one of those reference images, the set of pixels closest to the current block to be used as a predictor of that current block. The reference images used consist of images in the video sequence that have already been coded and then reconstructed (by decoding).

While the motion is usually estimated at the macroblock level, the H.264 standard also provides for partitioning the macroblock into smaller regions used for that motion estimation, for example sub-blocks of 4×4, 4×8, 8×4, 8×8, 8×16 or 16×8 pixels.

Generally, the motion estimation 104 is a “Block Matching Algorithm” (BMA).

The predictor block identified by this algorithm is next generated and then subtracted from the current data block to be processed so as to obtain a difference block (block residual). This step is called “motion compensation” 105 in the conventional compression algorithms.

These two types of coding thus supply several texture residuals (the difference between the current block and the predictor block) that are compared in a module for selecting the best coding mode 106 for the purpose of determining the one that optimizes a rate/distortion criterion.

If “Intra” coding is selected, prediction information for describing the “Intra” predictor is coded (109) before being inserted into the bit stream 110.

If the module for selecting the best coding mode 106 chooses “Inter” coding, prediction information such as motion information is coded (109) and inserted into the bit stream 110. This motion information is in particular composed of a motion vector (indicating the position of the predictor block in the reference image relative to the position of the block to be predicted) and appropriate information to identify the reference image among the reference images (for example an image index).

The residual selected by the choice module 106 is then transformed (107) in the frequency domain, by means of a discrete cosine transform DCT, and then quantized (108). The DCT transform and the quantization usually use blocks of size 4×4 or 8×8 pixels.

The coefficients of the quantized transformed residual are next coded by means of entropy or arithmetic coding (109) and then inserted into the compressed bit stream 110 as part of the useful data coding the blocks of the image.

In the remainder of the document, reference will mainly be made to entropy coding. However, a person skilled in the art is capable of replacing it with arithmetic coding or any other suitable coding.

In a particular coding mode of the H.264 standard, when no residual is provided for a macroblock, a Skipped Macroblock flag in the bit stream can be set to 1 instead of coding the motion vectors and the residuals, in order to reduce the number of bits to be coded. This is known as the Skip mode, as described for example in US application No 2009/0262835.

As is known per se, the bit stream corresponding to an encoded macroblock comprises a first part made of syntax elements and a second part made of encoded data for each data block.

The second part generally includes the encoded data corresponding to the encoded data blocks, i.e. the encoded residuals together with their associated motion vectors.

On the other hand, the first part made of syntax elements may represent encoding parameters which do not directly correspond to the encoded data of the blocks. For example, the syntax elements may comprise the macroblock address in the image, a quantization parameter, an indication of the elected Inter/Intra coding mode, the Skipped Macroblock flags and a so-called Coded Block Pattern (CBP) field indicating which blocks in the macroblock have corresponding encoded data in the second part.

In the specific case of the HEVC standard, a quadtree is provided as additional encoding information in the bitstream. The quadtree reflects a recursive breakdown of the image into square-shaped regions of pixels (an extension of the macroblocks) wherein each leaf node is a region formed with blocks to which similar encoding parameters are applied.

The identification of each region, also known as CTU, is then an additional encoding parameter that is transmitted in the bitstream for the decoder.

Further details of the HEVC standard are provided below.

In order to calculate the “Intra” predictors or to make the motion estimation for the “Inter” predictors, the encoder performs decoding of the blocks already encoded by means of a so-called “decoding” loop (111, 112, 113, 114, 115, 116) in order to obtain reference images for the future motion estimations. This decoding loop makes it possible to reconstruct the blocks and images from quantized transformed residuals.

It ensures that the coder and decoder use the same reference images.

Thus the quantized transformed residual is dequantized (111) by application of a quantization operation which is inverse to the one provided at step 108, and is then reconstructed (112) by application of the transformation that is the inverse of the one at step 107.

If the quantized transformed residual comes from an “Intra” coding 103, the “Intra” predictor used is added to that residual (113) in order to obtain a reconstructed block corresponding to the original block modified by the losses resulting from the quantization operation.

If on the other hand the quantized transformed residual comes from an “Inter” coding 105, the block pointed to by the current motion vector (this block belongs to the reference image 116 referred to in the coded motion information) is added to this decoded residual (114). In this way the original block is obtained, modified by the losses resulting from the quantization operations.

In order to attenuate, within the same image, the block effects created by strong quantization of the obtained residuals, the encoder includes a “deblocking” filter 115, the objective of which is to eliminate these block effects, in particular the artificial high frequencies introduced at the boundaries between blocks. The deblocking filter 115 smoothes the borders between the blocks in order to visually attenuate these high frequencies created by the coding. As such a filter is known from the art, it will not be described in further detail here.

The filter 115 is thus applied to an image when all the blocks of pixels of that image have been decoded.

The filtered images, also referred to as reconstructed images, are then stored as reference images 116 in order to allow subsequent “Inter” predictions based on these images to take place during the compression of the following images in the current video sequence.

The term “conventional” will be used below to refer to the information resulting from this decoding loop used in the prior art, that is to say in particular that the inverse quantization and inverse transformation are performed with conventional parameters. Thus reference will now be made to “conventional reconstructed image” or “conventional reconstruction”. As seen below, the same conventional parameters are generally used by the decoder to decode and display the encoded image.

In the context of the H.264 standard, a multiple reference option is provided for using several reference images 116 for the motion estimation and the motion compensation of the current image, with a maximum of 32 reference images taken from the conventional reconstructed images.

In other words, the motion estimation is performed on N images. Thus the best “Inter” predictor of the current block, for the motion compensation, is selected in one of the multiple reference images. Consequently two adjoining blocks can have respective predictor blocks that come from different reference images. This is in particular the reason why the second part of the bit stream associated with an encoded macroblock may further comprise, for each block (in fact the corresponding residual), the index of the reference image (in addition to the motion vector) used for the predictor block.

FIG. 3 illustrates this motion compensation by means of a plurality of reference images. In this Figure, the image 301 represents the current image during coding corresponding to the image i of the video sequence.

The images 302 and 307 correspond to the images i−1 to i-n that were previously encoded and then decoded (that is to say reconstructed) from the compressed video sequence 110.

In the example illustrated, three reference images 302, 303 and 304 are used in the Inter prediction of blocks of the image 301. To make the graphical representation legible, only a few blocks of the current image 301 have been shown, and no Intra prediction is illustrated here.

In particular, for the block 308, an Inter predictor 311 belonging to the reference image 303 is selected. The blocks 309 and 310 are respectively predicted by the blocks 312 of the reference image 302 and 313 of the reference image 304. For each of these blocks, a motion vector (314, 315, 316) is coded and provided with the index of the reference image (302, 303, 304).

The use of the multiple reference images—the recommendation of the aforementioned VCEG group recommending limiting the number of reference images to four should however be noted—is both a tool for providing error resilience and a tool for improving the efficacy of compression.

This is because, with an adapted selection of the reference images for each of the blocks of a current image, it is possible to limit the effect of the loss of a reference image or part of a reference image.

Likewise, if the selection of the best reference image is estimated block by block with a minimum rate-distortion criterion, this use of several reference images makes it possible to obtain significantly higher compression compared with the use of a single reference image.

FIG. 2 shows a general scheme of a video decoder 20 of the H.264/AVC type. The decoder 20 receives as an input a bit stream 201 corresponding to a video sequence 101 compressed by an encoder of the H.264/AVC type, such as the one in FIG. 1.

During the decoding process, the bit stream 201 is first of all entropy decoded (202), which makes it possible to process each coded residual.

The residual of the current block is dequantized (203) using the inverse quantization to that provided at 108, and then reconstructed (204) by means of the inverse transformation to that provided at 107.

Decoding of the data in the video sequence is then performed image by image and, within an image, block by block.

The “Inter” or “Intra” coding mode for the current block is extracted from the bit stream 201 and entropy decoded.

If the coding of the current block is of the “Intra” type, the index of the prediction direction is extracted from the bit stream and entropy decoded. The pixels of the decoded adjacent blocks most similar to the current block according to this prediction direction are used for regenerating the “Intra” predictor block.

The residual associated with the current block is recovered from the bit stream 201 and then entropy decoded. Finally, the Intra predictor block recovered is added to the residual thus dequantized and reconstructed in the Intra prediction module (205) in order to obtain the decoded block.

If the coding mode for the current block indicates that this block is of the “Inter” type, then the motion vector, and possibly the identifier of the reference image used, are extracted from the bit stream 201 and decoded (202).

This motion information is used in the motion compensation module 206 in order to determine the “Inter” predictor block contained in the reference images 208 of the decoder 20. In a similar fashion to the encoder, these reference images 208 may be past or future images with respect to the image currently being decoded and are reconstructed from the bit stream (and are therefore decoded beforehand).

The quantized transformed residual associated with the current block is, here also, recovered from the bit stream 201 and then entropy decoded. The Inter predictor block determined is then added to the residual thus dequantized and reconstructed, at the motion compensation module 206, in order to obtain the decoded block.

Naturally the reference images may result from the interpolation of images when the coding has used this same interpolation to improve the precision of prediction.

At the end of the decoding of all the blocks of the current image, the same deblocking filter 207 as the one (115) provided at the encoder is used to eliminate the block effects so as to obtain the reference images 208.

The images thus decoded constitute the output video signal 209 of the decoder, which can then be displayed and used. This is why they are referred to as the “conventional” reconstructions of the images.

These decoding operations are similar to the decoding loop of the coder.

The inventors of the present invention have however found that the compression gains obtained by virtue of the multiple reference option remain limited. This limitation is rooted in the fact that a great majority (approximately 85%) of the predicted data are predicted from the image closest in time to the current image to be coded, generally the image that precedes it.

In this context, several improvements have been developed.

For example, in the publication “Rate-distortion constrained estimation of quantization offsets” (T. Wedi et al., April 2005), based on a rate-distortion constrained cost function, a reconstruction offset is determined to be added to each transformed block before being encoded. This tends to further improve video coding efficiency by directly modifying the blocks to encode.

On the other hand, the inventors of the present invention have sought to improve the image quality of the reconstructed closest-in-time image used as a reference image. This aims at obtaining better predictors, and then reducing the residual entropy of the image to encode. This improvement also applies to other images used as reference images.

More particularly, in addition to generating a first reconstruction of a first image (let's say the conventional reconstructed image), the inventors have further provided for generating a second reconstruction of the same first image, where the two generations comprise inverse quantizing the same transformed blocks with however respectively a first reconstruction offset (or inverse quantization offset) and a second different reconstruction or inverse quantization offset applied to the same block coefficient.

As explained above, the transformed blocks are generally quantized DCT block residuals. As is known per se, the blocks composing an image comprise a plurality of coefficients each having a value. The manner in which the coefficients are scanned within the blocks, for example according to a zig-zag scan, defines a coefficient number for each block coefficient. In this respect, the expressions “block coefficient”, “coefficient index” and “coefficient number” will be used in the same way in the present application to indicate the position of a coefficient within a block according to the scan adopted.

For frequency-transformed blocks, there is usually a mean value coefficient (or zero-frequency coefficient) followed by a plurality of high frequency or “non-zero-frequency” coefficients.

On the other hand, “coefficient value” will be used to indicate the value taken by a given coefficient in a block.

In other words, the above improvements involve the invention having recourse to several different reconstructions of the same image in the video sequence, for example the image closest in time, so as to obtain several reference images for motion compensation of blocks in another image of the video sequence.

The different reconstructions of the same image here differ concerning different reconstruction offset values applied to the same block coefficients during the inverse quantization in the decoding loop.

Several parts of the same image to be coded can thus be predicted from several reconstructions of the same image which are used as reference images, as illustrated in FIG. 4.

At the encoding side, the motion estimation uses these different reconstructions to obtain better predictor blocks (i.e. closer to the blocks to encode) and therefore to substantially improve the motion compensation and the rate/distortion compression ratio. At the decoding side, they are correspondingly used during the motion compensation.

In the patent application published under the reference FR 2951345, filed by the same applicant and describing this novel approach for generating different reconstructions as reference images, from the same first image, there are described ways to automatically select a second reconstruction offset value different from the first reconstruction offset (for example a so-called “conventional” reconstruction offset, generally equal to zero), and to select the corresponding block coefficient index to which the different reconstruction offset must be applied.

In particular, there is provided a selection of the reconstruction offset and block coefficient pair based on distortion measures computed for each possible reconstruction offset and block coefficient pair. The distortion measures may be the SAD (absolute error—“Sum of Absolute Differences”), the SSD (quadratic error—“Sum of Squared Differences”) or the PSNR (“Peak Signal to Noise Ratio”) that is comparing generally a reconstructed image and its original image. The selection process sums the best distortion, block by block, among the conventional reconstruction of the first image and the reconstructions of the same first image. The pair which minimizes the sums is then selected.

However, this approach to selecting the second different reconstruction offset and the corresponding block coefficient has a high computational complexity resulting from successively considering each possible reconstruction offset and block coefficient pair, as well as from considering all blocks of the reconstructions when computing the distortion measures.

This may be prejudicial for encoding devices having limited resources, especially when the distortion measure involves demanding quadratic or square operations, like SSD or PSNR.

In an improved approach disclosed in the patent application FR 1050797 (not yet published) filed by the same applicant, different pairs of second reconstruction offset and corresponding block coefficient pairs are determined and used for different blocks to be reconstructed in the same first image. This results in having a second reconstruction, the blocks of which are reconstructed using different reconstruction offsets.

There is also known the weighted prediction offset (WPO) approach recently introduced in the H.264/AVC standard. The WPO scheme seeks to compensate the difference in illumination between two images, for example in case of illumination changes such as fading transitions.

In the WPO scheme, a second reconstruction of a first image is obtained by adding a pixel offset to each pixel of the image, regardless of the position of the pixel. Both reconstructions (the conventional reconstruction and the second reconstruction) may then be used as reference images for motion estimation and compensation.

Considering the DCT-transformed image, the WPO approach has the same effect as adding the same offset to the mean value block coefficient (or “DC coefficient”) of each DCT block, in the approach of FR 2951345. The offset is for example computed by averaging the two images surrounding the first image.

Even if the WPO approach reduces the number of reconstruction offset and block coefficient pairs to be successively considered (since the block coefficient is always the DC coefficient), there is a need to decrease the complexity when determining an optimum reconstruction offset for a second reconstruction, while not dramatically decreasing the coding efficiency.

Similar drawbacks exist with respect to the HEVC standard which provides similar mechanisms.

The HEVC standard introduces new specificities as stated above, in particular it provides new coding entities compared to the H.264/AVC standard. Three of these new coding entities are now described.

As briefly introduced above, HEVC implements a quadtree that is encoded in the bitstream. The quadtree represents the partition of an image into coding units (CUs), starting from a first subdivision of the image into square-shaped groups of pixels, referred to as CTB (standing for “Coded Tree Block”).

The CTB entity is an extension of the macroblock found in the H.264/AVC standard.

A CTB can be subdivided into four equally-shaped sub-CTBs or not. This subdivision is indicated in the quadtree by a bit currently named the “split_flag”. Each sub-CTB can also be recursively subdivided.

Depending on the number of recursive subdivisions of the CTB, several depths are obtained: each CTB is then assigned a depth in the quadtree. When a CTB is not further subdivided, it is a coding unit grouping blocks that are to be coded using the same encoding parameters.

The quadtree thus represents a collection of non-overlapping coding blocks.

In the HEVC standard, the CTB can have any of the sizes 128×128, 64×64, 32×32, 16×16 or 8×8. An encoder may however restrict the minimum and maximum sizes, thus changing the maximum depth possible and the matching between CTB depth and CTB size.

This is illustrated with reference to FIG. 12 which illustrates a CTB of size 128×128 and depth 0 named CU₀.

If its “split_flag” is 0 as seen on the left part, then it is not further subdivided. Otherwise, as seen on the right, there are 4 sub-CTBs of depth 1 (thus of size 64×64).

Again, each of them can have their “split_flag” set to 0 or 1 as illustrated with CU₁ on respectively left and right parts.

The “split flag” is associated with reach CTB or sub-CTB until the last possible depth. This is because, if the encoder minimum CTB size is reached, there no further CTB splitting is possible.

At each depth, the CTB is said to be 2N×2N while each corresponding sub-CTB is said to be N×N.

It may be noted that this new entity CTB affects the SKIP mode provided in the H.264/AVC standard, since there is now a need to specify the size of the skipped CTB in order, for the decoder, to be able to select the next block (CTB) to process.

Another new entity introduced by the HEVC standard is the Prediction Unit, referred to as PU.

This is an extension of the partitioning of H.264/AVC for motion estimation, which is defined for each CTB that is not further subdivided (“split flag”=0).

In addition to the regular symmetrical partitions of H.264/AVC (i.e. 4×4 and 8×8, 4×8, 8×4, 8×16, 16×8), HEVC introduces asymmetrical partitions which split the CTB into a ¾ part and a ¼ part.

This is illustrated with reference to FIG. 13 which shows the eight possible PUs for a 64×64 CTB, four of which being asymmetrical. From left to right and top to bottom, the partitions are 64×64, 64×32, 32×64, 32×32, 64×16 and 64×48, 16×64 and 48×64.

It may be noted that this new coding entity PU affects how an image is interpolated, and causes possible discontinuities in the motion field (and thus the motion-compensated reference image) due to different interpolations used for adjacent PU.

The third new coding entity is known as Transform Unit, or TU.

While H.264/AVC allowed two transform sizes (4×4 and 8×8) for the DCT and quantization/dequantization, HEVC currently offers the additional sizes of 2N×2N and N×N for each CTB (for example 16×16 and 32×32). Given these new sizes for quantization/dequantization, this new coding entity TU introduces new quantization errors.

The present invention seeks to overcome all or parts of the above drawbacks of the prior art, in particular to reduce the computational complexity of the reconstruction parameter selection and then the encoding time, i.e. when selecting an efficient reconstruction offset and possibly a corresponding block coefficient.

In some embodiments, the invention further seeks to achieve this aim while maintaining the coding efficiency or while having a negligible degradation in visual quality.

### SUMMARY OF THE INVENTION

In this respect, the invention concerns in particular a method for encoding a video sequence comprising a succession of images made of data blocks, the method comprising:
encoding a first image into an encoded first image;
obtaining a second reconstruction offset that is different from a first reconstruction offset;
generating first and second reconstructions of the same encoded first image by applying respectively the first reconstruction offset and the second different reconstruction offset to the same block coefficient of at least one block; and
encoding a second image using temporal prediction in which a reference image is selected from a set of reference images that includes the first and second reconstructions;

wherein the obtaining of the second different reconstruction offset comprises:
determining a subset of data blocks of the first image, based on the encoding of the first image;
for each offset from a set of reconstruction offsets, estimating a distortion measure between the blocks of the first reconstruction that are collocated with the determined subset and the blocks of an image reconstruction of the encoded first image using said offset that are collocated with the determined subset; and
based on the estimated distortion measures, selecting one of the reconstruction offsets as the second different reconstruction offset for generating the second reconstruction.

According to the invention, the distortion measures are estimated based on a restricted set of data blocks. The computational complexity when selecting a second reconstruction offset is therefore reduced. In addition, reconstructing a whole first image for each offset of the set of reconstruction offsets is avoided since this is done only for the determined subset of blocks. In some cases, the first image may be entirely reconstructed using only the reconstruction offset that is eventually selected.

Furthermore, the coding efficiency may be substantially maintained compared to the case with an estimation based on all the data blocks. This results from using the encoding of the first image to restrict the set of data blocks. This is because the encoded bit stream comprises encoding information that is generally useful to easily identify the most relevant data blocks (e.g. those blocks that most diverge from the original first image) based on which a relevant second reconstruction offset may be computed.

The selection of the second different reconstruction parameter according to the invention is therefore faster than in the known techniques, thus reducing the time to encode a video sequence.

In addition to the approach of FR 2951345, the invention as defined above may also be applied to the selection of the reconstruction offset for the DC coefficient in the WPO scheme.

Determining the subset of data blocks may appear as a key step since the distortion measures for selecting the second reconstruction offset are limited thereto. In this respect, the invention may further provide, based on encoding parameters used for the encoding of the first image, defining partitions of data blocks; and

selecting, as the determined subset of data blocks, the blocks of the first image corresponding to at least one of the defined partitions.

Defining partitions based on encoding parameters ensures that subsets are obtained that have similar behaviors during the encoding, in particular because they share similar encoding parameters.

The reconstruction offset obtained through distortion estimation from a subset is thus optimized at least for that subset, improving the efficiency of motion compensation of a second image based on the blocks of the second reconstruction (i.e. using that optimized offset) collocated with that subset. This may be done for example based on the encoding mode (or prediction type) referred to as SKIP mode, or the equivalent (lack of additional information such as motion or residual). However, further criteria, in particular based on the HEVC standard as described below, may be involved for partitioning the images.

In addition, the encoding parameters are easily accessed by the encoder and are also known by the decoder (e.g. because they are inserted in the bitstream) ensuring that the partitioning by the encoder and by the decoder is easily obtained and is the same.

According to a particular feature, defining partitions is based on at least one encoding parameter chosen from the group comprising:
the size or depth of coded tree blocks with which the data blocks of the first image are associated, a coded tree block grouping all data blocks of a square-shaped region of the first image when they share the same encoding parameters;
the type of prediction units (in particular their size) applied to the data blocks (or the corresponding coded tree block) when encoding the first image with prediction;
the size of the transform units applied to the data blocks (or the corresponding coded tree block) when encoding the first image with transform;
the coding mode (also known as prediction type, i.e. skip [or merged in HEVC], inter or intra) applied to the data blocks (or the corresponding coded tree block) when encoding the first image.

These parameters are particularly adapted to the HEVC standard since they respectively correspond to the CTB size (or depth), the PU size, the TU size and the skip/inter/intra coding mode. Based on the HEVC quadtree, the various possible CTB, PU and TU sizes may be easily determined, resulting in a quick partitioning of the first encoded image.

According to another particular feature, the method further comprises dividing the determined subset corresponding to the selected partition into analysis units of the same size, the analysis units being the blocks based on which the distortion measure is estimated. In the case of the HEVC standard, the analysis unit size is generally set smaller than or equal to the CTB size defining the selected partition.

Applying a specific analysis unit size makes it possible to control the complexity of the distortion estimation as well as to control the range of possible values for the reconstruction offset and/or for the corresponding block coefficient index.

In this respect, it may be provided for the method to further comprise determining the set of reconstruction offsets based on the size of the analysis units. In this context, adjusting the analysis unit size adjusts the complexity of the distortion estimation, since a variable number of reconstruction offsets may be tested depending on the analysis unit size.

In particular, the method may further comprise determining a set of block coefficients based on the size of the analysis units to define a set of reconstruction offset and block coefficient pairs; and in that case,

each pair from the defined set of reconstruction offset and block coefficient pairs is considered when estimating the distortion measures, and the obtaining of the second different reconstruction offset comprises selecting one of the reconstruction offset and block coefficient pairs based on the estimated distortion measures, to obtain a second different reconstruction offset and the corresponding block coefficient to which the obtained second different reconstruction offset is applied.

This embodiment reflects the approach of FR 2951345 to obtain second reconstructions as very efficient reference images when encoding other images of the video sequence.

In particular, the block coefficient of each pair considered when estimating a distortion measure may be the mean value coefficient of the data blocks. In this case, the invention particularly applies to the WPO scheme.

Again, when adjusting the analysis unit size, the complexity of calculation is adjusted. This is because when the analysis unit size varies the number of block coefficients also varies (e.g. a 4×4 block only comprises 16 coefficients, while a 8×8 blocks has 64 coefficients).

In order to take advantage of the analysis unit size impact so as to obtain a more efficient reconstruction offset and block coefficient pair, it is also provided for the method to further comprise successively considering several sizes of analysis units to select the analysis unit size, the reconstruction offset, and possibly the block coefficient, that provide the best estimated distortion measure, for generating the second reconstruction.

In particular, the number of analysis unit sizes to successively consider depends on the encoding parameters defining the selected partition. For example, the analysis unit size may not exceed the CTB size when the latter is a criterion to define the current partition.

In one embodiment, the analysis unit size is also encoded in the bitstream together with the reconstruction offset, and the possible block coefficient. Thanks to the knowledge of the analysis unit size (from which derives the number of possible reconstructions offsets and block coefficients), it is possible to optimize the encoding of those reconstruction offset and possible block coefficient pairs (using the fewer bits, by entropy encoding). However, since this implies an overhead in the encoded bitstream, selecting the analysis unit size, the reconstruction offset, and possibly the block coefficient for generating the second reconstruction may be further (i.e. in addition to the distortion measures) based on an encoding cost to encode the analysis unit size, the reconstruction offset, and the possible block coefficient.

In a variant, only the distortion measures are taken into account.

In one embodiment of the invention, the method comprises directly partitioning the first image based on the encoding parameters, and then selecting one of the partitions as the determined subset of data blocks.

In a variant in which the partitions are defined by knowledge of the possible encoding parameters, some partitions do not correspond to coded blocks in the first image. In this case, the method may comprises determining whether or not the encoded first image comprises blocks corresponding to a defined partition before selecting that partition to define the determined subset of data blocks. If appropriate, that partition can be discarded, avoiding having to perform certain steps as described below.

According to a particular embodiment of the invention, the method further comprises successively considering a plurality of determined subsets of data blocks corresponding to a plurality of said defined partitions to obtain a corresponding plurality of reconstruction offsets, and possibly block coefficients and analysis unit sizes, for generating the second reconstruction of the first image;

wherein generating the second reconstruction combines reconstructed blocks of the first image, two blocks corresponding to two different partitions being reconstructed using their respective obtained reconstruction offset, and possibly block coefficient and analysis unit size.

In this configuration, the second reconstruction combines several reconstruction offsets for different parts of the image. This results in a second reconstruction that is locally optimized for each of its portions.

According to a particular embodiment of the invention, the encoded first image comprises syntax elements representing encoding parameters and encoded data corresponding to the encoded data blocks of the first image, and the determining of the subset is based on the syntax elements.

This provision makes it possible to handle little information in the course of determining the relevant data blocks to be considered. This contributes to further reducing the complexity of the reconstruction parameters (reconstruction offset and possible corresponding block coefficient) selection process.

In particular, the determining of the subset comprises selecting the data blocks that belong to non-skipped macroblocks of the encoded first image, as said subset of data blocks. This selection may be easily achieved thanks to the Skipped Macroblock flag included in the syntax elements. Generally, the proportion of non-skipped macroblocks in an image varies between 25% (for low bitrate video) and 50% (for high bitrate video)

Based on experimental simulations, it has been observed that such an approach can provide a decrease of 55% in the computational complexity compared to considering all the data blocks, while substantially maintaining the coding efficiency compared to the approach of FR 2951345.

According to a variant, the determining of the subset comprises selecting, as said subset of data blocks, the data blocks belonging to a macroblock with which a non-zero Coded Block Pattern field is associated in the encoded first image. This selection may be easily achieved thanks to the CBP field included in the syntax elements.

Still based on experimental simulations, it has been observed that this approach can provide a decrease of about 60% in the computational complexity.

The coding efficiency and image quality may however slightly decrease, but remain substantially acceptable with reference to the approach of FR 2951345.

According to another variant, the determining of the subset comprises selecting, as said subset of data blocks, the data blocks with which a Coded Block Pattern bit equal to 1 is associated in the encoded first image. This selection may also be easily achieved thanks to the CBP field included in the syntax elements. Indeed such a CBP field for a macroblock is conventionally a sequence of bits, a respective bit of the sequence being associated with each data block in the macroblock. Selecting only the blocks associated with a CBP bit=1, further reduces the number of data blocks taken into account when estimating the distortion measures.

Still based on experimental simulations, it has been observed that this approach can further decrease the computational complexity to a decrease of about 62%.

The coding efficiency and image quality may however slightly decrease, but remain substantially acceptable compared to the approach of FR 2951345.

In one embodiment of the invention, the estimating of a distortion measure comprises comparing:

an error measure between respective data blocks of the first reconstruction and of the first image before encoding that are collocated with a block of the determined subset,

with an error measure between the corresponding data blocks of the image reconstruction and of the first image before encoding that are collocated with said block of the determined subset.

Such approach makes it possible to evaluate how much closer to the original first image (before encoding) is a combination of the image reconstruction and the first reconstruction (generally the conventional reconstruction).

It is then easy to select, based on the distortion measures, the second different reconstruction offset that gives the closest combination to the original first image. Coding efficiency can therefore be substantially maintained.

According to one embodiment of the invention, during the distortion measure estimation, a block of an image reconstruction of the encoded first image using said offset is obtained from the collocated block of the first reconstruction by adding to it a corrective residual block obtained by inverse quantizing a block of coefficients all equal to zero in which a block coefficient with zero value has been modified by adding the said offset.

In another embodiment having similarities, the generating of the second reconstruction comprises:
obtaining a corrective residual block by inverse quantizing a block of coefficients all equal to zero (which has the same size as the above analysis unit when used), in which a block coefficient with zero value has been modified by adding the obtained second different reconstruction offset (in particular the corresponding reconstruction block coefficient); and
adding the obtained corrective residual block to each data block of the first reconstruction that is collocated with a block of the determined subset, so as to obtain the second reconstruction.

These two embodiments further reduce complexity of the encoding process since, in those cases, only one reconstruction of the encoded first image is required (e.g. the first conventional reconstruction), the other reconstructions resulting from adding various corrective residual blocks to this first reconstruction. Less demanding processing, used for computing the corrective residual blocks from a zero block, are then implemented to obtain the other reconstructions from the first reconstruction.

Of course, the corrective residual block has the same size as the analysis unit defined above when such unit is used.

As one may note, such a mechanism using a corrective residual block may also be implemented during decoding to obtain the same second reconstruction as a reference image for further prediction.

Correspondingly, the invention concerns a device for encoding a video sequence comprising a succession of images made of data blocks, comprising:
encoding means for encoding a first image into an encoded first image;
means for obtaining a second reconstruction offset that is different from a first reconstruction offset;
generation means for generating first and second reconstructions of the same encoded first image by applying respectively the first reconstruction offset and the second different reconstruction offset to the same block coefficient of at least one block; and
encoding means for encoding a second image using temporal prediction in which a reference image is selected from a set of reference images that includes the first and second reconstructions;

wherein the means for obtaining the second different reconstruction offset are configured to:
determine a subset of data blocks of the first image, based on the encoding of the first image;
for each offset from a set of reconstruction offsets, estimate a distortion measure between the blocks of the first reconstruction that are collocated with the determined subset and the blocks of an image reconstruction of the encoded first image using said offset that are collocated with the determined subset; and
based on the estimated distortion measures, select one of the reconstruction offsets as the second different reconstruction offset for generating the second reconstruction.

The encoding device, or encoder, has advantages similar to those of the method disclosed above, in particular that of reducing the complexity of the encoding process while maintaining its efficiency.

Optionally, the encoding device can comprise means relating to the features of the method disclosed previously.

The invention also concerns a method for decoding a bitstream representing an encoded video sequence comprising a succession of images made of data blocks, the method comprising:
obtaining encoding parameters associated with an encoded first image;
based on the encoding parameters, defining partitions of data blocks;
selecting a partition so as to decode, from the bitstream, an associated analysis unit size and an associated second reconstruction offset that is different from a first reconstruction offset;
generating first and second reconstructions of the same encoded first image by applying respectively the first reconstruction offset and the second different reconstruction offset to the same block coefficient of analysis-unit-sized blocks of the selected partition; and
decoding a second image using temporal prediction in which a reference image is selected from a set of reference images that includes the first and second reconstructions.

This decoding method particularly applies to bitstreams resulting from the above encoding method, when the first image is partitioned based on encoding parameters, and when a specific analysis unit size is used for each partition to estimate the distortions and select the second reconstruction offset. This may be for example when applying some above embodiments of the encoding method with the HEVC standard.

In one embodiment, each defined partition is successively selected to decode associated analysis unit sizes and second reconstruction offsets; and

wherein generating the second reconstruction comprises reconstructing the analysis-unit-sized blocks corresponding to each partition using the decoded second reconstruction offset associated with that partition.

As suggested above for the encoding, there may also be a block coefficient specifically associated with each partition, in which case that associated block coefficient is used when reconstructing the analysis-unit-sized blocks corresponding to the same partition.

In addition, the reconstruction may be performed by adding an appropriate corrective residual block to the collocated blocks of the first reconstruction as defined above for the encoding method.

According to another feature, the decoding of the second reconstruction offset (and of a possible corresponding block coefficient) associated with a partition depends on its decoded associated analysis unit size. This is the case when a restricted group of possible offsets and block coefficient is defined for each analysis unit size, in which case the encoding of that information in the bitstream may have been optimized (entropy coding) by the encoder.

The invention also concerns a corresponding decoding device.

The invention also concerns an information storage means, possibly totally or partially removable, able to be read by a computer system, comprising instructions for a computer program adapted to implement a method according to the invention when that program is loaded into and executed by the computer system.

The invention also concerns a computer program able to be read by a microprocessor, comprising portions of software code adapted to implement a method according to the invention, when it is loaded into and executed by the microprocessor.

The information storage means and computer program have features and advantages similar to the methods that they use.

### BRIEF DESCRIPTION OF THE DRAWINGS

Other particularities and advantages of the invention will also emerge from the following description, illustrated by the accompanying drawings, in which:

FIG. 1 shows the general scheme of a video encoder of the prior art;

FIG. 2 shows the general scheme of a video decoder of the prior art;

FIG. 3 illustrates the principle of the motion compensation of a video coder according to the prior art;

FIG. 4 illustrates the principle of the motion compensation of a coder including, as reference images, multiple reconstructions of at least the same image;

FIG. 5 shows a first embodiment of a general scheme of a video encoder using a temporal prediction on the basis of several reference images resulting from several reconstructions of the same image;

FIG. 6 shows the general scheme of a video decoder according to the first embodiment of FIG. 5 enabling several reconstructions to be combined to generate an image to be displayed;

FIG. 7 shows a second embodiment of a general scheme of a video encoder using a temporal prediction on the basis of several reference images resulting from several reconstructions of the same image;

FIG. 8 shows the general scheme of a video decoder according to the second embodiment of FIG. 7 enabling several reconstructions to be combined to generate an image to be displayed;

FIG. 9 illustrates an exhaustive computation of a distortion measure in an encoding scheme of FIG. 5 or 7;

FIG. 10 illustrates an optimized computation of a distortion measure according to an embodiment of the invention;

FIG. 11 shows a particular hardware configuration of a device able to implement one or more methods according to the invention;

FIG. 12 shows a recursive quadtree-based structure of a top-level Coded Tree Block of size 128×128, as defined in the HEVC standard;

FIG. 13 shows the various possible Partition Unit types for a 64×64 Coded Tree Block, as defined in the HEVC standard;

FIG. 14 illustrates the selection of reconstruction parameters for a plurality of partitions resulting from an image segmentation, at the encoding according to another embodiment of the invention; and

FIG. 15 illustrates the decoding corresponding to the encoding of FIG. 14.

### DETAILED DESCRIPTION OF EMBODIMENTS OF THE INVENTION

In the context of the invention, the coding of a video sequence of images comprises the generation of two or more different reconstructions of at least the same image based on which motion estimation and compensation is performed for encoding another image. In other words, the two or more different reconstructions, using different reconstruction parameters, provide two or more reference images for the motion compensation or “temporal prediction” of the other image.

The processing operations on the video sequence may be of a different nature, including in particular video compression algorithms. In particular the video sequence may be subjected to coding with a view to transmission or storage.

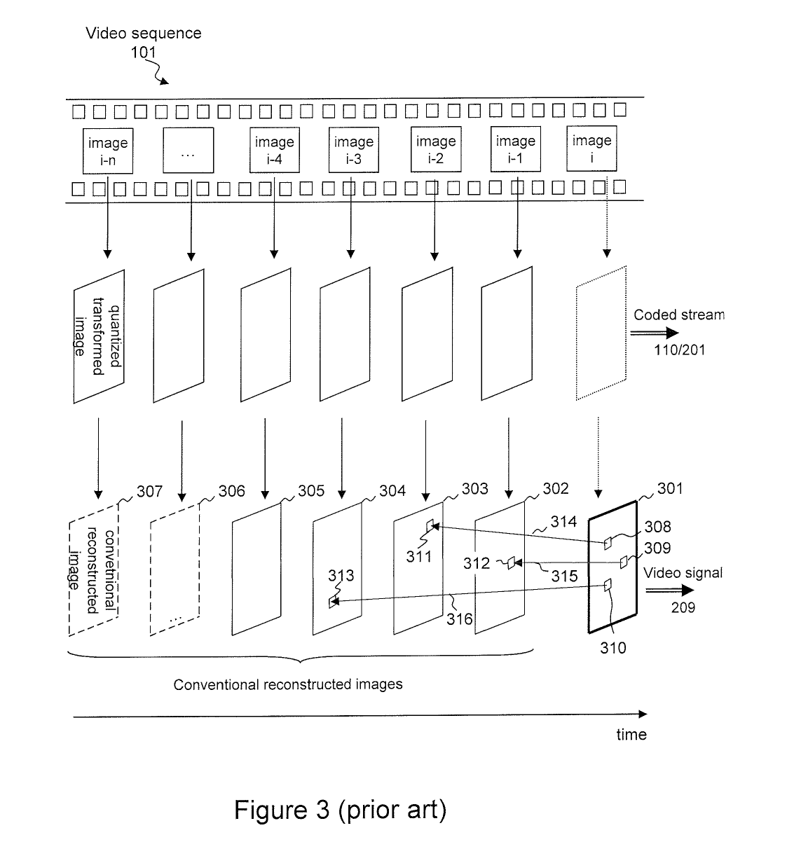

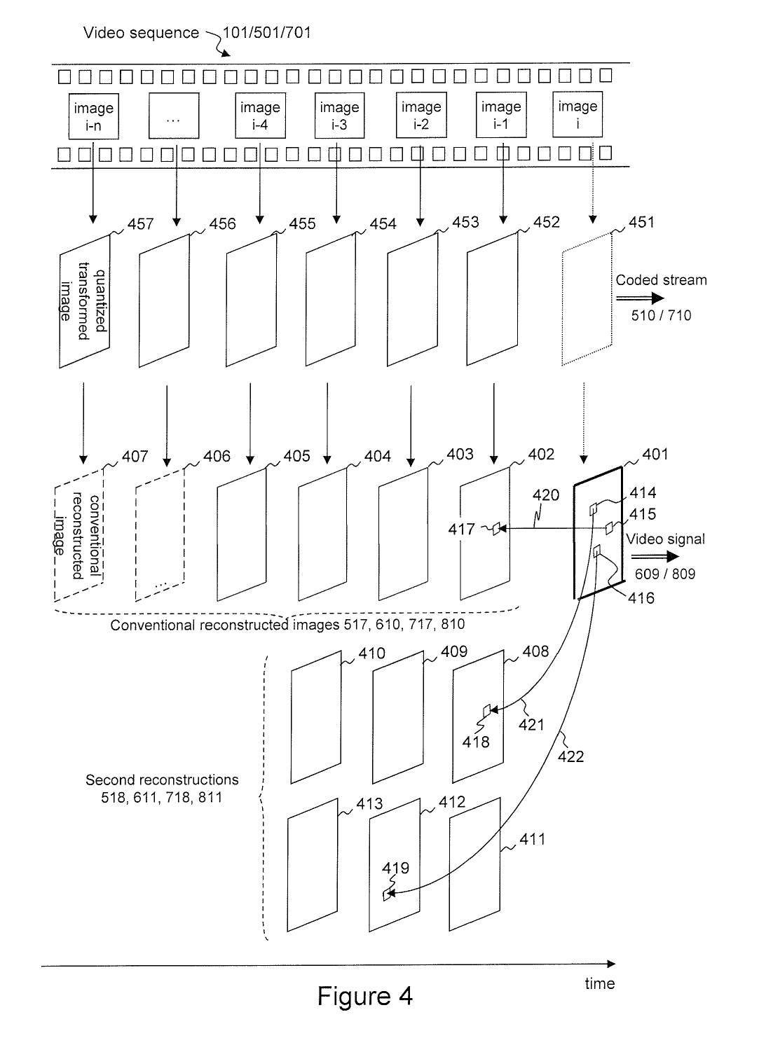

FIG. 4 illustrates motion compensation using several reconstructions of the same reference image as taught in the above referenced French application No 2951345, in a representation similar to that of FIG. 3.

The “conventional” reference images 402 to 405, that is to say those obtained according to the prior art, and the new reference images 408 to 413 generated through other reconstructions are shown on an axis perpendicular to the time axis (defining the video sequence 101) in order to show which reconstructions correspond to the same conventional reference image.

More precisely, the conventional reference images 402 to 405 are the images in the video sequence that were previously encoded and then decoded by the decoding loop: these images therefore correspond to those generally displayed by a decoder of the prior art (video signal 209) using conventional reconstruction parameters.

The images 408 and 411 result from other decodings of the image 452, also referred to as “second” reconstructions of the image 452. The “second” decodings or reconstructions mean decodings/reconstructions with reconstruction parameters different from those used for the conventional decoding/reconstruction (according to a standard coding format for example) designed to generate the decoded video signal 209.

As seen subsequently, these different reconstruction parameters may comprise a DCT block coefficient and a reconstruction offset θᵢ used together during an inverse quantization operation of the reconstruction (decoding loop).

As explained below, the present invention provides a method for selecting “second” reconstruction parameters (here the block coefficient and the reconstruction offset), when coding the video sequence 101.

Likewise, the images 409 and 412 result from second decodings of the image 453. Lastly, the images 410 and 413 result from second decodings of the image 454.

In the Figure, the block 414 of the current image 401 has, as its Inter predictor block, the block 418 of the reference image 408, which is a “second” reconstruction of the image 452. The block 415 of the current image 401 has, as its predictor block, the block 417 of the conventional reference image 402. Lastly, the block 416 has, as its predictor, the block 419 of the reference image 412, which is a “second” reconstruction of the image 453.

In general terms, the “second” reconstructions 408 to 413 of an image or of several conventional reference images 402 to 407 can be added to the list of reference images 116, 208, or even replace one or more of these conventional reference images.

It should be noted that, generally, it is more effective to replace the conventional reference images with “second” reconstructions, and to keep a limited number of new reference images (multiple reconstructions), rather than to routinely add these new images to the list. This is because a large number of reference images in the list increases the rate necessary for the coding of an index of these reference images (in order to indicate to the decoder which one to use).

However, a reference image that is generated using the “second” reconstruction parameters may be added to the conventional reference image to provide two reference images used to motion estimation and compensate for other images in the video sequence.

Likewise, it has been possible to observe that the use of multiple “second” reconstructions of the first reference image (the one that is the closest in time to the current image to be processed; generally the image that precedes it) is more effective than the use of multiple reconstructions of a reference image further away in time.

In order to identify the reference images used during encoding, the coder transmits, in addition to the total number and the reference number (or index) of reference images, a first indicator or flag to indicate whether the reference image associated with the reference number is a conventional reconstruction or a “second” reconstruction. If the reference image comes from a “second” reconstruction according to the invention, reconstruction parameters relating to this second reconstruction, such as the “block coefficient index” and the “reconstruction offset value” (described subsequently) are transmitted to the decoder, for each of the reference images used.

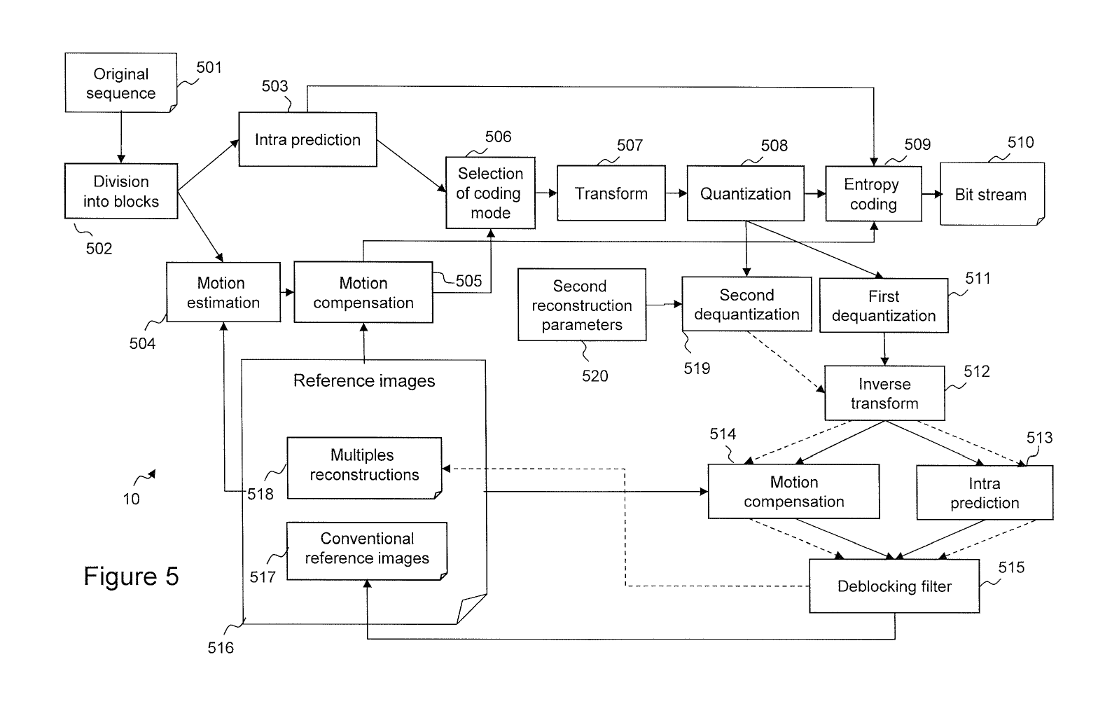

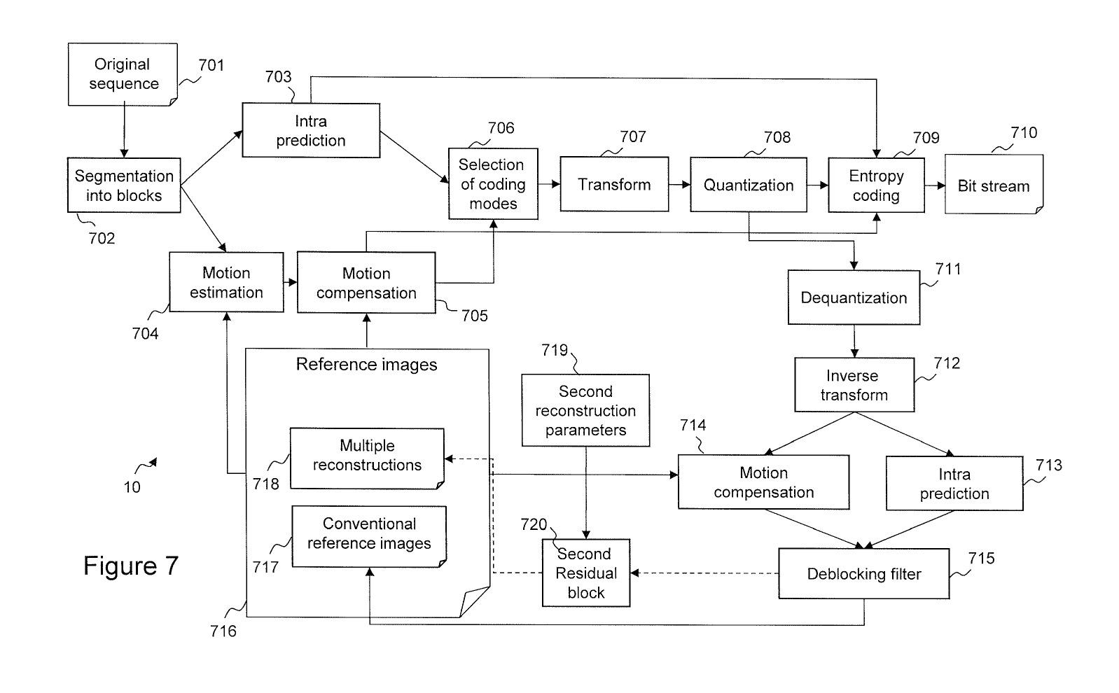

With reference to FIGS. 5 and 7, a description is now given of two alternative methods of coding a video sequence, using multiple reconstructions of a first image of the video sequence.

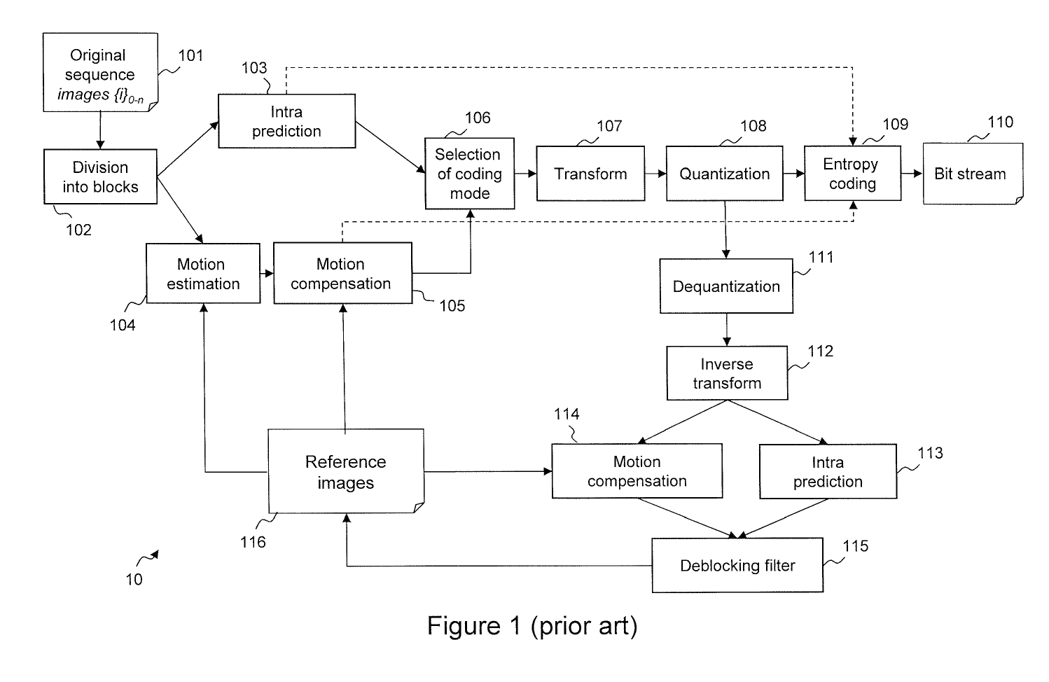

Regarding the first embodiment, a video encoder 10 comprises modules 501 to 515 for processing a video sequence with a decoding loop, similar to the modules 101 to 115 in FIG. 1.

In particular, according to the standard H.264, the quantization module 108/508 performs a quantization of the residual of a current pixel block obtained after transformation 107/507, for example of the DCT type. The quantization is applied to each of the N values of the coefficients of this residual block (as many coefficients as there are in the initial pixel block). Calculating a matrix of DCT coefficients and running through the coefficients within the matrix of DCT coefficients are concepts widely known to persons skilled in the art and will not be detailed further here. In particular, the way in which the coefficients are scanned within the blocks, for example a zigzag scan, defines a coefficient number for each block coefficient, for example a mean value coefficient DC and various coefficients of non-zero frequency ACᵢ.

Thus, if the value of the i^{th} coefficient of the residual of the current DCT transformed block is denoted Wᵢ (the DCT block having the size N×N [for example 4×4 or 8×8 pixels], with i varying from 0 to M−1 for a block containing M=N×N coefficients, for example W₀=DC and Wᵢ=ACᵢ), the quantized coefficient value Zᵢ is obtained by the following formula:

$${Z}_{i} = int ( \frac{\vert {W}_{i} \vert + {f}_{i}}{{q}_{i}} ) \cdot sgn ( {W}_{i} )$$

where qᵢ is the quantizer associated with the i^{th} coefficient whose value depends both on a quantization parameter denoted QP and the position (that is to say the number or index) of the coefficient value Wᵢ in the transformed block.

To be precise, the quantizer q, comes from a matrix referred to as a quantization matrix of which each element (the values qᵢ) is predetermined. The elements are generally set so as to quantize the high frequencies more strongly.

Furthermore, the function int(x) supplies the integer part of the value x and the function sgn(x) gives the sign of the value x.

Lastly, fᵢ is the quantization offset which enables the quantization interval to be centered. If this offset is fixed, it is in general equal to qᵢ/2.

On finishing this step, the quantized residual blocks are obtained for each image, ready to be coded to generate the bitstream 510. In FIG. 4, these images bear the references 451 to 457.

The inverse quantization (or dequantization) process, represented by the module 111/511 in the decoding loop of the encoder 10, provides for the dequantized value W′ᵢ of the i^{th} coefficient to be obtained by the following formula:

W′ᵢ=(qᵢ·|Zᵢ|−θᵢ)·sgn(Zᵢ).

In this formula, Zᵢ is the quantized value of the i^{th} coefficient, calculated with the above quantization equation. θᵢ is the reconstruction offset that makes it possible to center the reconstruction interval. By nature, θᵢ must belong to the interval [−|fᵢ|;|fᵢ|], i.e. generally to the interval

$$[ - \vert \frac{{q}_{i}}{2} \vert ; \vert \frac{{q}_{i}}{2} \vert ] .$$

To be precise, there is a value of θᵢ belonging to this interval such that W′ᵢ=Wᵢ. This offset is generally set equal to zero (θ₀=0) for the conventional reconstruction (to be displayed as decoded video output).

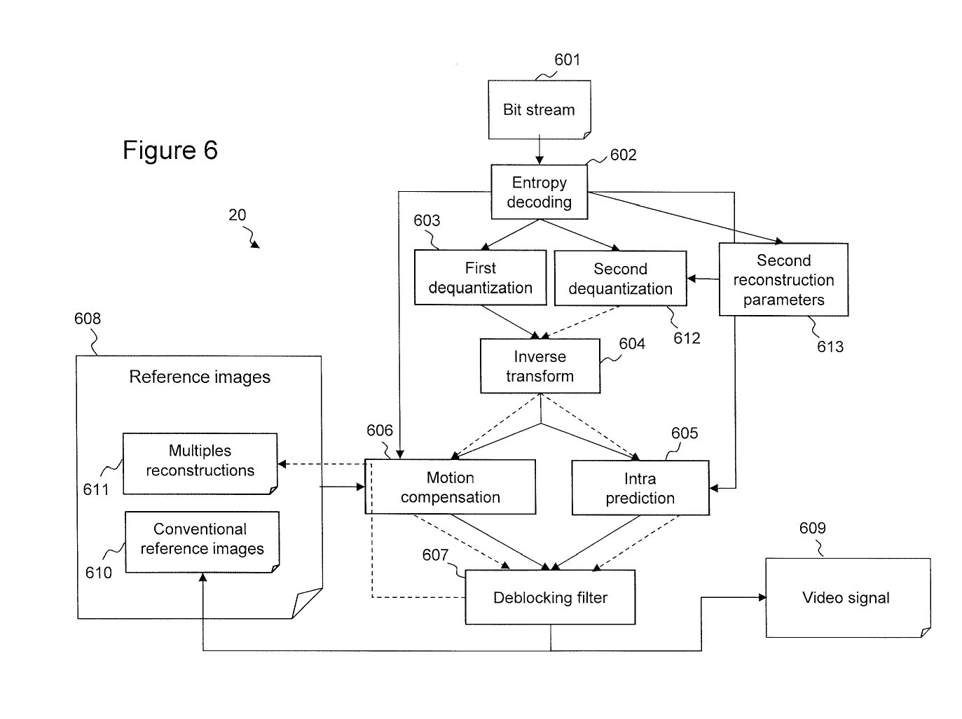

It should be noted that this formula is also applied by the decoder 20, at the dequantization 203 (603 as described below with reference to FIG. 6).

Still with reference to FIG. 5, the module 516 contains the reference images in the same way as the module 116 of FIG. 1, that is to say that the images contained in this module are used for the motion estimation 504, the motion compensation 505 on coding a block of pixels of the video sequence, and the motion compensation 514 in the decoding loop for generating the reference images.

The so-called “conventional” reference images 517 have been shown schematically, within the module 516, separately from the reference images 518 obtained by “second” decodings/reconstructions according to the invention.

In particular, the “second” reconstructions of an image are constructed within the decoding loop, as shown by the modules 519 and 520 enabling at least one “second” decoding by dequantization (519) by means of “second” reconstruction parameters (520).

Thus, for each of the blocks of the current image, two dequantization processes (inverse quantization) 511 and 519 are used: the conventional inverse quantization 511 for generating a first reconstruction (using θ₀ for each DCT coefficient for example) and the different inverse quantization 519 for generating a “second” reconstruction of the block (and thus of the current image).

It should be noted that, in order to obtain multiple “second” reconstructions of the current reference image, a larger number of modules 519 and 520 may be provided in the encoder 10, each generating a different reconstruction with different reconstruction parameters as explained below. In particular, all the multiple reconstructions can be executed in parallel with the conventional reconstruction by the module 511.

Information on the number of multiple reconstructions and the associated reconstruction parameters are inserted in the coded stream 510 for the purpose of informing the decoder 20 of the values to use.

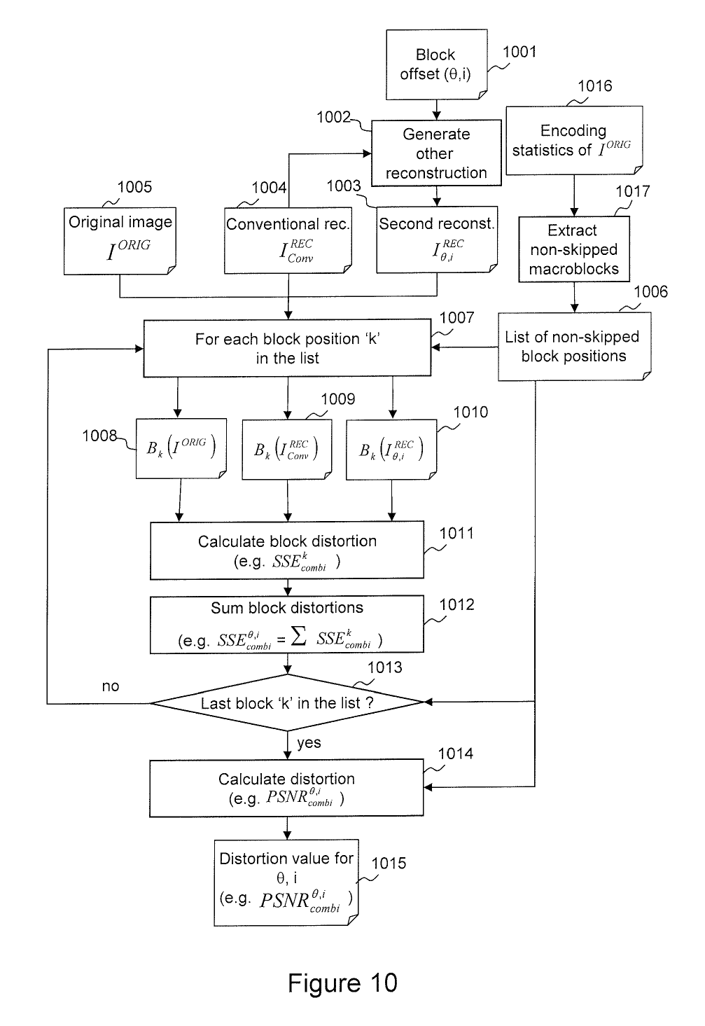

The module 519 receives the reconstruction parameters of a second reconstruction 520 different from the conventional reconstruction. The present invention details below, with reference to FIG. 10, the operation of this module 520 to determine and select efficiently reconstruction parameters for generating a second reconstruction. The reconstruction parameters received are for example a coefficient number i of the quantized transformed residual (e.g. DCT block) which will be reconstructed differently and the corresponding reconstruction offset θᵢ, as described elsewhere.

These reconstruction parameters may in particular be determined in advance.

These two reconstruction parameters generated by the module 520 are entropically encoded at module 509 then inserted into the binary stream (510), in the syntax elements.

In module 519, the inverse quantization for calculating W′ᵢ is applied using the reconstruction offset θᵢ, for the block coefficient i, as defined in the parameters 520. In an embodiment, for the other coefficients of the block, the inverse quantization is applied with the conventional reconstruction offset (generally θ₀, used in module 511). Thus, in this example, the “second” reconstructions may differ from the conventional reconstruction by the use of a single different reconstruction parameter pair (coefficient, offset).

In particular, if the encoder uses several types of transform or several transform sizes, a coefficient number and a reconstruction offset may be transmitted to the decoder for each type or each size of transform.

It is however possible to apply several reconstruction offsets θᵢ to several coefficients within the same block. It is also possible to differently reconstruct two blocks (i.e. using different reconstruction parameters).

At the end of the second inverse quantization 519, the same processing operations as those applied to the “conventional” signal are performed. In detail, an inverse transformation 512 is applied to that new residual (which has thus been transformed 507, quantized 508, then dequantized 519). Next, depending on the coding of the current block (Intra or Inter), a motion compensation 514 or an Intra prediction 513 is performed.

Lastly, when all the blocks (414, 415, 416) of the current image have been decoded, this new reconstruction of the current image is filtered by the deblocking filter 515 before being inserted among the multiple “second” reconstructions 518.

Thus, in parallel, there are obtained the image decoded via the module 511 constituting the conventional reference image, and one or more “second” reconstructions of the image (via the module 519 and other similar modules the case arising) constituting other reference images corresponding to the same image of the video sequence.

In FIG. 5, the processing according to the invention of the residuals transformed, quantized and dequantized by the second inverse quantization 519 is represented by the arrows in dashed lines between the modules 519, 512, 513, 514 and 515.

It will therefore be understood here that, like the illustration in FIG. 4, the coding of a following image may be carried out by block of pixels, with motion compensation with reference to any block from one of the reference images thus reconstructed, “conventional” or “second” reconstruction.

FIG. 7 illustrates a second embodiment of the encoder in which the “second” reconstructions are no longer produced from the quantized transformed residuals by applying, for each of the reconstructions, all the steps of inverse quantization 519, inverse transformation 512, Inter/Intra determination 513-514 and then deblocking 515. These “second” reconstructions are produced more simply from the “conventional” reconstruction producing the conventional reference image 517. Thus the other reconstructions of an image are constructed outside the decoding loop.

In the encoder 10 of FIG. 7, the modules 701 to 715 are similar to the modules 101 to 115 in FIG. 1 and to the modules 501 and 515 in FIG. 5. These are modules for conventional processing according to the prior art.

The reference images 716 composed of the conventional reference images 717 and the “second” reconstructions 718 are respectively similar to the modules 516, 517, 518 of FIG. 5. In particular, the images 717 are the same as the images 517.

In this second embodiment, the multiple “second” reconstructions 718 of an image are calculated after the decoding loop, once the conventional reference image 717 corresponding to the current image has been reconstructed.

The “second reconstruction parameters” module 719 supplies for example a coefficient number i and a reconstruction offset θᵢ to the module 720, referred to as the corrective residual module. A detailed description is given below with reference to FIG. 10, of the operation of this module 719 to determine and efficiently select the reconstruction parameters to generate a second reconstruction, in accordance with the invention. As for module 520, the two reconstruction parameters produced by the module 719 are entropically coded by the module 709, and then inserted in the bitstream (710).

The module 720 calculates an inverse quantization of a DCT block, the coefficients of which are all equal to zero (“zero block”), to obtain the corrective residual module.

During this dequantization, the coefficient in the zero block having the position “i” supplied by the module 719 is inverse quantized by the equation W′ᵢ=(qᵢ·|Zᵢ|−θᵢ)·sgn(Zᵢ) using the reconstruction offset θᵢ supplied by this same module 719 which is different from the offset (θ₀ generally zero) used at 711. This inverse quantization results in a block of coefficients, in which the coefficient with the number i takes the value θᵢ, and the other block coefficients for their part remain equal to zero.

The generated block then undergoes an inverse transformation, which provides a corrective residual block.

Next the corrective residual block is added to some or each of the blocks of the conventionally reconstructed current image 717 in order to supply a new reference image, which is inserted in the module 718.

This may be summarized by the following equation at block level:

Bₖ(I_{θ,i}^{REC})=Bₖ(I_{Conv}^{REC})+B^{θ,i}

where Bₖ(I_{θ,i}^{REC}) is the k-th block in the second reconstruction; Bₖ(I_{Conv}^{REC}) is the k-th block in the conventional reconstruction; and B^{θ,i} is the corrective residual block based on the second reconstruction parameters (θ, i) for the second reconstruction

Furthermore, since two blocks of the second reconstruction can be differently reconstructed (i.e. using different reconstruction parameters), several corrective residual blocks may be used to generate the second reconstruction, each being added to a part of the blocks of the conventionally reconstructed current image 717.

It will therefore be remarked that the module 720 produces one or several corrective residual blocks aimed at correcting the conventional reference image as “second” reference images as they should have been by application of the second reconstruction parameters used (at the module 719).

This method is less complex than the previous one firstly because it avoids performing the decoding loop (steps 711 to 715) for each of the “second” reconstructions and secondly since it suffices to calculate the corrective residual block only once at the module 720.

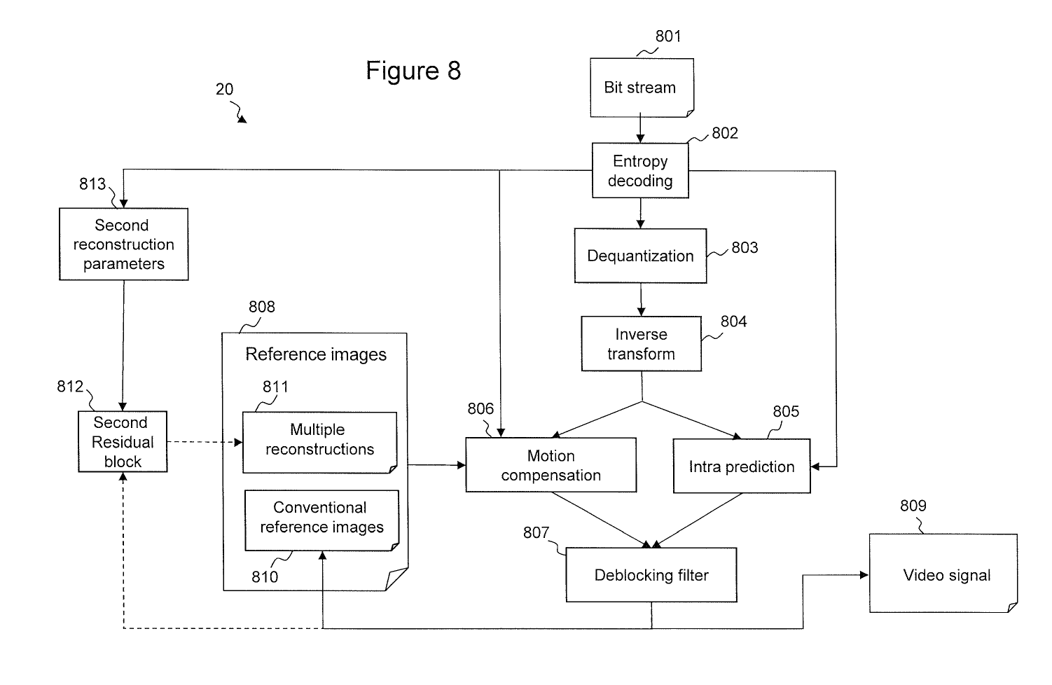

FIGS. 6 and 8 illustrate a decoder 20 corresponding to respectively the first embodiment of FIG. 5 and the second embodiment of FIG. 7.

As can be seen from these Figures, the decoding of a bit stream is similar to the decoding operations in the decoding loops of FIGS. 5 and 7, but with the retrieval of the reconstruction parameters from the bitstream 601, 801 itself.

The “second reconstruction parameters” module that provides a second reconstruction offset according to the teachings of the invention, when encoding a video sequence is now discussed.

As introduced above, the application No. FR 2951345 suggests providing a selection of the second reconstruction offset and corresponding block coefficient based on distortion measures (SAD, SSD, PSNR) computed for each possible reconstruction offset and block coefficient pair. The estimated distortion measures for the pairs enable the best reconstruction offset and corresponding block coefficient to be found, in order to obtain an optimized coding efficiency.

In one example, the criterion for selecting the best reconstruction offset/block coefficient may be the following:

Max(PSNR((I_{θ,i}^{REC}|I_{Conv}^{REC}),I^{ORIG}))_{∀(θ,i)} or

Min(SSE((I_{θ,i}^{REC}|I_{Conv}^{REC}),I^{ORIG}))_{∀(θ,i)}

where I^{ORIG} is the first image before encoding; I_{Conv}^{REC} is the conventional reconstruction of the first image I^{ORIG}; I_{θ,i}^{REC} is the reconstruction of the same first image using the reconstruction parameters (θ, i); and PSNR(I₁/I₂, I₀) [resp. SSE] is the PSNR [resp. SSE] of the combination of I₁ with I₂, with respect to I₀.

Let Bₖ (I) denote the k-th data block in the image I. Given a division of the image I into blocks, the index k of the blocks may increase along a row, one row after the other, from the top-left block to the bottom-right block in the image.

Let bₗ^{k} (I) denote the value of the I-th pixel in Bₖ (I). In a 4×4 pixel block, l takes 16 values. For illustrative purpose, a luminance pixel may be coded over 1 byte, i.e. its value may vary from 0 to 255.

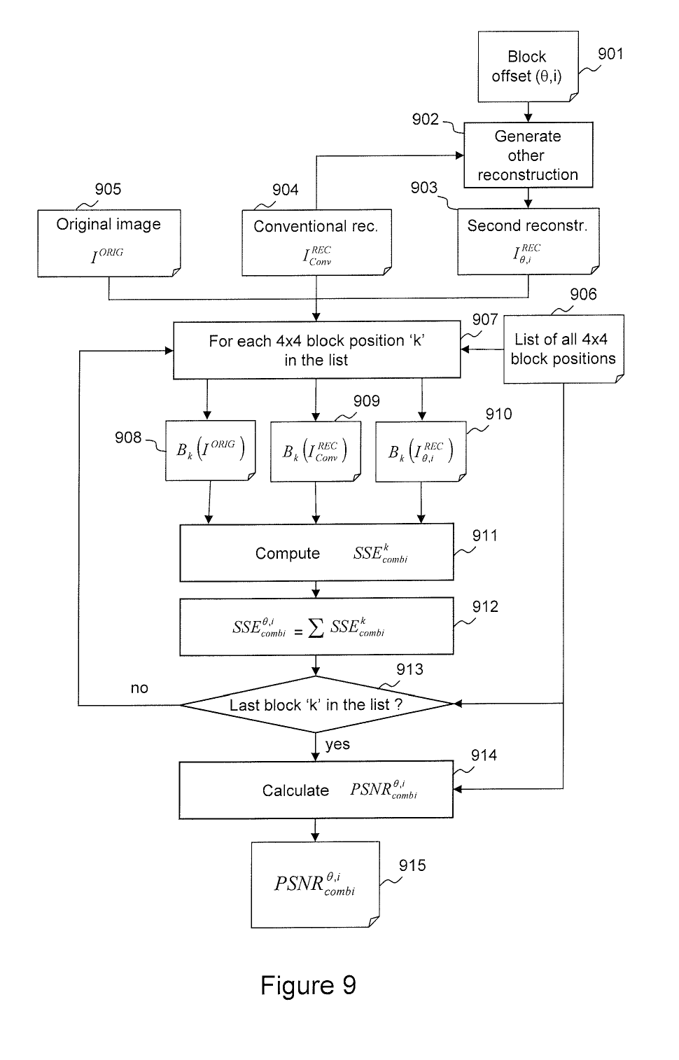

FIG. 9 illustrates one way to compute or estimate a distortion measure for one reconstruction offset and block coefficient pair, although it is not disclosed as such in FR 2951345.

As explained above, the range

$$[ - \vert \frac{{q}_{i}}{2} \vert ; \vert \frac{{q}_{i}}{2} \vert ]$$

defines the possible reconstruction offsets. A subset of this range may however be selected to decrease the number of pairs to consider (to which the steps of FIG. 9 have to be applied). For example, this range may be restricted to several discrete values such as the subset

$$\{ - \frac{q}{2} ; - \frac{q}{4} ; - \frac{q}{6} ; - \frac{q}{8} ; \frac{q}{8} ; \frac{q}{6} ; \frac{q}{4} ; \frac{q}{2} \} .$$

The possible block coefficients comprise all coefficients of the DCT blocks, i.e. the mean value (DC) coefficient and the non-zero frequency (AC) coefficients.

Again, a subset of these coefficients may be used to decrease the number of pairs to consider for selecting the second reconstruction parameters.

In the case of the WPO scheme, only the DC coefficient is considered.

Consider a given reconstruction parameter pair (θ, i) from the possible reconstruction offset and block coefficient pairs (module 901).

At step 902, an image reconstruction I_{θ,i}^{REC} of the first image I^{ORIG} is generated using the considered pair (θ, i). In the example of the Figure, this image reconstruction is generated from the conventional reconstruction I_{Conv}^{REC}, i.e. according to the approach of FIG. 7: Bₖ (I_{θ,i}^{REC})=Bₖ(I_{Conv}^{REC})+B^{θ,i}.

In this example, the size of the corrective residual block B^{θ,i} is the same as the DCT blocks. In some embodiments of the invention, the image reconstruction is based on blocks having other sizes. For this reason, below, reference will be made to “analysis units” for these sized blocks based on which the distortion analysis is performed.

Of course, the approach of FIG. 5 may be contemplated as a variant.

The image reconstruction I_{θ,i}^{REC} is therefore obtained (module 903), in parallel to the obtaining of the first image before encoding I^{ORIG} (module 905) and the conventional reconstruction I_{Conv}^{REC} (module 904).

Module 906 contains all the data block positions k within the first image I^{ORIG}, i.e. every position in the image corresponding to one of the data blocks that divide the first image. The data blocks are for example 4×4 pixels blocks, but may be of any other size defined in H.264.

As introduced above with the “analysis units”, other block sizes that do not correspond to sizes conventionally defined in H.264 can be used in the present invention, such as the CTB sizes provided in the HEVC standard.

The loop between steps 907 and 913 permits successive consideration of each block position listed in the module 906.

At step 907, the 4×4 block Bₖ (I^{ORIG}) at the current position k is extracted from the first image I^{ORIG}, the 4×4 block Bₖ (I_{Conv}^{REC}) at the current position k is extracted from the conventional reconstruction I_{Conv}^{REC} of the first image, and the 4×4 block Bₖ (I_{θ,i}^{REC}) at the current position k is extracted from the image reconstruction I_{θ,i}^{REC} using the current pair (θ, i). These extracted blocks are collocated in their respective images, and wear the references 908, 909 and 910 in the Figure.

At step 911, a SSE (Sum of Squared Error) Combination for the current block k is computed using the three collocated extracted blocks Bₖ(I^{ORIG}), Bₖ (I_{Conv}^{REC}), Bₖ (I_{θ,i}^{REC}):

$$S S {E}_{combi}^{k} = min ( {\sum }_{l} {( {b}_{l}^{k} ( {I}^{ORIG} ) - {b}_{l}^{k} ( {I}_{θ , i}^{REC} ) )}^{2} , {\sum }_{l} {( {b}_{l}^{k} ( {I}^{ORIG} ) - {b}_{l}^{k} ( {I}_{Conv}^{REC} ) )}^{2} )$$

The first component of the min function represents an error measure between the respective current block k from the second reconstruction and from the first image before encoding.

The second component of the min function represents an error measure between the respective current block k from the first (conventional) reconstruction and from the first image before encoding.

At step 912, a cumulative SSE Combination value SSE_{combi}^{θ,i} is updated for the current pair (θ, i), by adding the SSE Combination value computed at step 911 to the previously computed SSE Combination values:

SSE_{combi}^{θ,i}=SSE_{combi}^{θ,i}+SSE_{combi}^{K}

In this way, when all the data blocks have been successively considered, the cumulative SSE Combination SSE_{combi}^{θ,i} sums all minimum SSEs computed for the data blocks.

At step 914, the distortion measure PSNR_{combi}^{θ,i} for the current pair (θ, i) is then calculated based on the obtained cumulative SSE Combination SSE_{combi}^{θ,i}.

For example, the following formula may be used:

$${PSNR}_{combi}^{θ , i} = 10 \cdot {log}_{10} ( \frac{{255}^{2} \cdot nb\_Pixels}{S S {E}_{combi}^{θ , i}} )$$

where 255 stands for the number of possible values for a pixel component (in this case the pixel component is coded over 1 byte) and nb_Pixels is the number of pixels for all the block positions (i.e. it is the total number of pixels within the first image, since every data block position is successively considered).

The distortion measure PSNR_{combi}^{θ,i} thus obtained is compared to the distortion measures obtained for the other possible pairs (θ, i) in order to identify the best pair for generating the second reconstruction according to the invention. For example, the selected pair is the pair corresponding to

$${max}_{θ , i} ( {PSNR}_{combi}^{θ , i} ) .$$

The complexity of this distortion measure PSNR_{combi}^{θ,i} is more than twice the complexity of a conventional PSNR. This is because, for each pixel position, two subtractions and two square operations are computed.

Moreover, the encoding computational complexity resulting from the use of such selection process annihilates the benefits of fast motion estimation. This is because, since the distortion measure PSNR_{combi}^{θ,i} is computed for each possible block offset (θ, i), it is computed 333 times when a quantization parameter (QP) is equal to 33.

The present invention seeks to optimize such a process for selecting the second reconstruction parameters, in particular by reducing the complexity of computing the distortion measure, e.g. PSNR_{combi}^{θ,i}.

As it will become clear from the following explanations with reference to FIG. 10, the idea of the invention is to reduce the number of pixels used during this computation of the distortion measure.

In the embodiment of this Figure, this is achieved by reducing the number of block positions that have to be considered (i.e. listed in the module 906) to only the blocks belonging to a partition of the blocks within the encoded first image from which the conventional reconstruction has been generated.

The partition may for example identify the non-skipped macroblocks.

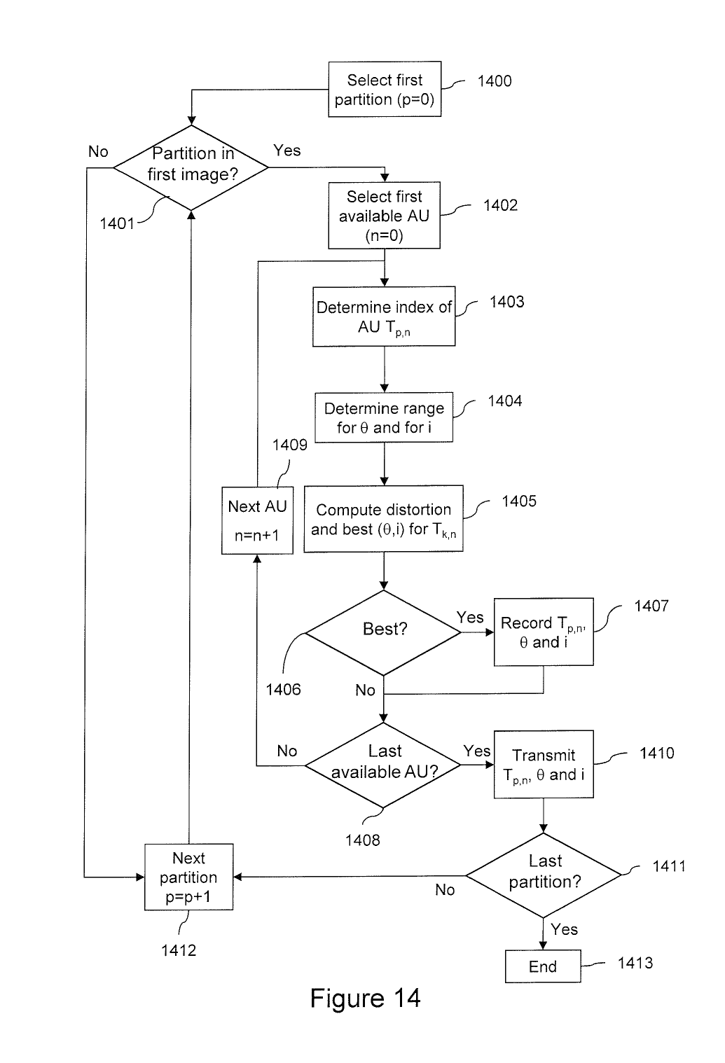

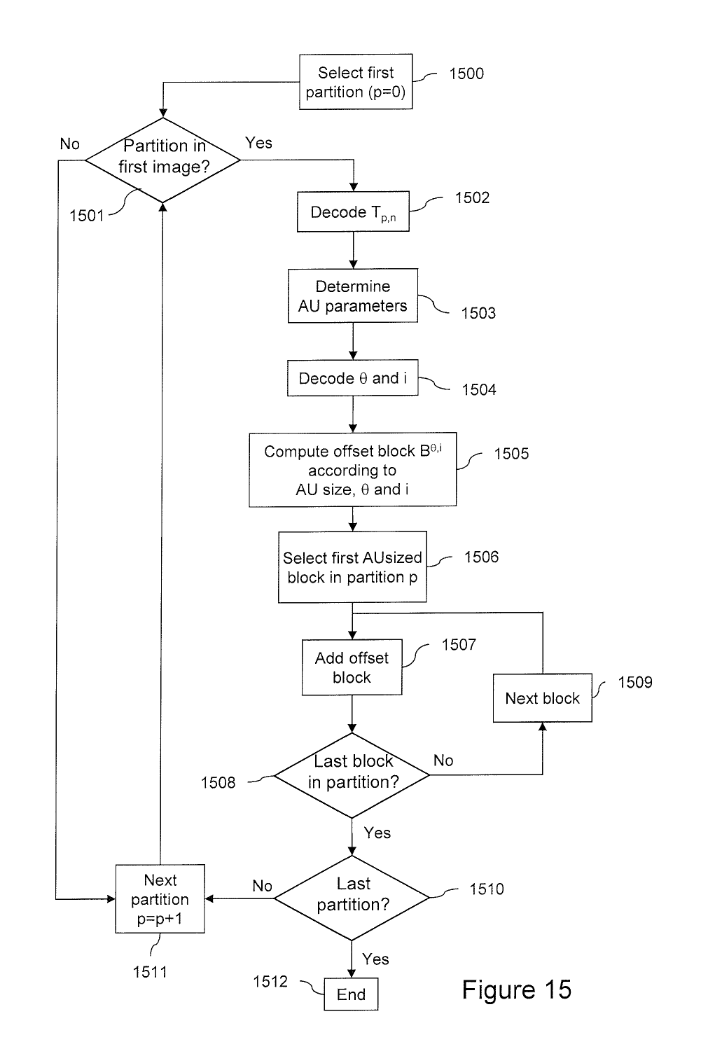

Other examples, as illustrated below with reference to FIGS. 14 and 15, use HEVC encoding parameters (CTB, PU, UT, coding mode) to provide a partitioning of a first image encoded using HEVC.

Other variants may consider other criteria to reduce the number of block positions, such as considering the macroblocks or data blocks with respect to the value of their associated Coded-Block Pattern field in the bit stream.

According to this approach, an exemplary method according to the invention comprises:
generating two reconstructions from the same encoded first image, using two different reconstruction offsets;
encoding a second image using temporal prediction based on a reference image selected from a set comprising the two reconstructions;

wherein the obtaining of a different reconstruction offset comprises:
selecting the blocks of the encoded first image belonging to a defined partition, e.g. the non-skipped macroblocks or to the macroblocks with non-zero coded-block pattern;
for several reconstruction offsets (θ), estimating a distortion measure based only on blocks collocated with these selected blocks, between the first reconstruction and an image reconstruction of the encoded first image using each offset; and
selecting the reconstruction offset associated with the minimum distortion measure (e.g. a maximum PSNR—Peak signal-to-noise ratio).

In FIG. 10, the modules (1001) to (1005) and (1007) to (1015) operate substantially in the same way as respectively the modules (901) to (905) and (907) to (915). As introduced above, the blocks used in 1007-1010 may have the same size as the analysis unit (defined below) which may have a size different from the DCT.

An example is described first in which the list of block positions is based on the non-skipped macroblocks.

Next, another example will be described with reference to FIG. 14, in which this list of block positions, and the possible reconstruction parameters used to generate the block offset 101, result from the use of HEVC encoding parameters.

The module 1016 contains the encoding statistics of the encoded first image (from which the conventional reconstruction I_{Conv}^{REC} has been generated). The statistics have been retrieved from the data generated to build the bit stream. The retrieved statistics are for example the syntax elements as introduced above.

In step 1017, a list of block positions is determined based on these statistics. In particular, the list lists the block positions belonging to non-skipped macroblocks. This information is easily obtained using the syntax elements, in particular from the Skipped Macroblock flags (or fields) that are specified for the macroblocks of the encoded first image.

Consequently, the module 1006 comprises the list of the non-skipped 4×4 block positions. This list is a subset of the list of all block positions as it is used in the approach of FIG. 9. In particular, the proportion of non-skipped macroblocks is on average 25% for a compression with low bitrates and reaches 50% at high bitrates (under typical conditions defined for example by the standardization groups VCEG and MPEG).

Based on this restricted list of block positions, the loop 1007-1013 is executed fewer times. The number of SSE_{combi}^{k} computations is therefore reduced, so is the computation complexity of the method.

At step 1014, the number of pixels nb_Pixels must be adjusted to the number of pixels composing the blocks of the restricted list (i.e. composing the non-skipped macroblock).

Experimentally, it has been observed that the method of FIG. 10 decreases the computational complexity of the reconstruction parameter selection by 55% compared to the approach of FIG. 9. Moreover, the coding efficiency is substantially maintained since the selected reconstruction parameters are optimal for the less predictable areas in the image (i.e. the areas that create most of the distortion due to coding).

While the invention described with reference to FIG. 10 considers several possible block coefficients, the method according to the invention may also be applied to selecting an optimized second reconstruction offset when the block coefficient is fixed (for example only the DC coefficient is considered).

This is for example the case when applying the invention to the WPO scheme as introduced above. In this case, the invention makes it possible to find the best second reconstruction offset for the DC coefficient. Practically, in the module 1001, “i” always designates the DC coefficient (i=0).

Variants to selecting the non-skipped macroblocks in step 1017 to constitute the restricted set of block positions may be implemented. These variants differ from FIG. 10 in that step 1017 performs another selecting operation and step 1016 may involve various kinds of information relating to encoding of I^{ORIG}.

According to a first variant, step 1017 lists the positions of corresponding data blocks that belong to macroblocks with a Coded Block Pattern (CBP) different from zero. This information may be easily retrieved from the syntax elements in the bit stream (at the CBP field).

Since the CBP field specifies whether or not a macroblock comprises a residual or residuals (CBP=0 means that no residual has been coded for the macroblock, while CBP≧1 means that one or more residuals have been coded), considering the macroblocks with CBP≠0 ensures that only the macroblocks having blocks that substantively differ from the initial first image are considered.

The number of data blocks in the list 1006 is further reduced, since all the skipped macroblocks have CBP=0 (they have no residual). The computational complexity is consequently further reduced.

Experimentally, the computational complexity reduction appears to be about 60% compared to the approach of FIG. 9 (i.e. with the use of all block positions). The coding efficiency is however slightly decreased, but in a non prejudicial manner for the display quality of the decoded video.

According to a second variant, step 1017 lists the positions corresponding the data blocks that have a residual, i.e. that correspond to a CBP bit equal to 1 at block level. This information may be easily retrieved from the syntax elements in the bit stream, at the CBP field since this field has several bits, each of them corresponding to a specific data block within the macroblock.

The number of data blocks in the list 1006 is consequently further reduced compared to the first variant. The computational complexity is then also further reduced, to about 62% of reduction, even if the coding efficiency is a little more decreased, but without reducing the display quality of the decoded video.

Another variant is illustrated with reference to FIG. 14, in which selecting second reconstruction parameters is adapted to the entities newly introduced by the HEVC standard, namely the encoding parameters CTB, PU and TU.

This example is based on a natural segmentation of the encoded first image (from which the first conventional reconstruction has been produced) to identify similar blocks to which similar reconstruction parameters are applied to produce the second reconstruction.

In more detail, this approach provides for defining partitions of data blocks based on these parameters and on the encoded first image, to select at least one partition of data blocks as the list 1006 of data blocks to successively consider in 1007.

The segmentation or partitioning of the HEVC-encoded first image into non-overlapping partitions of data blocks comprises subdividing the pixels of the first image into blocks characterized by their CTB depth and/or TU size and/or coding mode (i.e. inter/intra/skip mode) and/or PU type. Other characteristics or encoding parameters locally applied to the pixels/blocks of the encoded first image may also be taken into account.

A plurality of partitions of data blocks then derives from those characteristics, some partitions being possibly not represented by a block within the encoded image.

For illustrative purposes only, the following criteria are used:
whether the coding mode is equivalent to SKIP or not;
whether the CTB depth is 0 or not;
the transform TU size (there are for example about 4 sizes);
whether the PU type is 2N×2N or not;

Depending on how the criteria are arranged, this may result in various partitions. For example, the following exemplary partitions are defined:
partition 0 is defined by coding mode=SKIP and depth=0 (TU size and PU have no meaning);
partition 1 is defined by coding mode=SKIP and depth>0;
partition 2 is defined by coding mode!=SKIP, transform size=N×N and CTB depth=last available;
partition 3 is defined by coding mode!=SKIP, transform size=N×N and CTB depth<last available.

A last partition defined by the remaining blocks may be used. In a variant, these remaining blocks may be excluded for the distortion analysis.

The “last available” depth is the depth at which the CTB has exactly the same size as TU size.

One may note that this example is closely related to what the encoder and standard allow. In this respect, entities or other encoding parameters that could be introduced in future standards may also be used to provide partitioning of the encoded first image.

With reference to FIG. 14, a process to determine the possible reconstruction parameters (θ, i) and the list 1006 of blocks for each of these defined partitions is now described. Of course, the same process may be applied when only one partition is to be considered.

A first partition from amongst the defined partitions is first selected at step 1400.

At step 1401, it is tested whether or not that selected partition occurs in the first image. In other words, it is determined whether or not the encoded first image comprises blocks corresponding to that selected partition.

This test is easily handled by the encoder, since the latter has already encoded the first image, and thus knows which encoding parameters (i.e. corresponding to partitions) are used to encode each block of the image.

In case the selected partition does not occur in the encoded first image, a next partition is selected at step 1412 before going back to test 1401.

Identifying the partitions that do not occur in the first image is important since, in that case, it may be avoided to send (within the bitstream to the decoder), information about that partition (e.g. reconstruction parameters θ, I and T_{p,n} as introduced below).

According to the embodiment of FIG. 14, each partition that occurs in the first image is thus successively selected to obtain corresponding optimum reconstruction offsets and block coefficients, for generating the second reconstruction of the first image.

For a given selected partition (“current partition” associated with the index ‘p’ on the Figure), a first available Analysis Unit (AU) is selected at step 1402, in order to initialize the loop (through 1408 and 1409) finding the “best” AU.

The Analysis Unit (AU) defines a generic block on which the different reconstruction parameters are applied in order to obtain a second reconstruction. In the equation Bₖ (I_{θ,i}^{REC})=Bₖ(I_{Conv}^{REC})+B^{θ,i}, the corrective residual block B^{θ,i} is built on the format of the Analysis Unit.

The Analysis Unit is mainly defined by its size. This is because, for example, the number of block coefficients ‘i’ to which a reconstruction offset may be applied directly depends on the AU size: for example a 4×4 AU defines a corrective residual block having 16 block coefficients, while a 8×8 AU has 64 coefficients.

Other constraints may also be applied to an AU: for example the number of possible reconstruction offsets may be limited. In this respect, two different AUs may have the same size but a different number of possible reconstruction offsets.

In the present embodiment, each AU is uniquely identified. With each AU is associated an AU size, a set of possible block coefficients (that may be less than AU size x AU size) and a set possible reconstruction offsets.

At step 1402, a first available Analysis Unit (AU) is selected.

Here reference is made to “available” AU. This is because the number of possible AUs for a given partition may vary, depending on the partition characteristics, in particular on the CTB/PU/TU used to define the partition.

For example, some AUs have sizes that are greater than the size of the CTB characterizing the current partition. Thus, they have to be disregarded.

Furthermore, artificial limitations on the AUs can be set, based on partitioning or the encoding parameters used for partitioning. For example, a fixed AU may be defined for a given partition. However; it is not worth testing more than four values of i for a 4×4 AU size.

Based on the first AU selected (in the Figure, n being the iteration index), an index identifying the selected AU is determined at step 1403. This index/identifier is denoted T_{p,n} for the current partition p. When the possible AUs differ from each other only by their sizes, the AU identifier may be the AU size.

At step 1404, the range of available reconstruction parameters (i.e. possible reconstruction offsets θ and possible block coefficients i) for the current AU T_{p,n} is obtained. This defines a set of possible reconstruction offset and block coefficient pairs.

Following step 1404 is step 1405 which is the determination of the pair (θ, i) that provides the least distortion of the possible pairs, for the current AU T_{p,n} and the current partition p.

This step may implement several iterations of the process of FIG. 10, for each possible reconstruction offset and block coefficient pair as obtained in step 1404, and select the pair with the best distortion measure as obtained in step 1015.

During those iterations, the list 1006 of block positions is the list of AU-sized blocks which are in the current partition p (considering the current AU T_{p,n}). In other words, the partition is divided or segmented into AU-sized blocks, which blocks are used for the computation of the distortion measures:
collocated AU-sized Bₖ(I_{Conv}^{REC}) is retrieved from the conventional reconstruction of the first image;
collocated AU-sized Bₖ (I^{ORIG}) is retrieved from the first image itself;
AU-sized B^{θ,i} is obtained from an AU-sized block of coefficients all equal to zero;
and AU-sized Bₖ(I_{θ,i}^{REC}) is retrieved from Bₖ (I^{ORIG}) and B^{θ,i}.

The best pair (θ, i) and its corresponding distortion measure are thus obtained for the current AU T_{p,n} at the end of step 1405.

At step 1406, it is determined whether or not this obtained distortion measure is better (in the meaning of less distortion in the image) than the currently-best distortion measure stored for the current partition p.

For the first AU T_{p,n} considered, there is no currently-best distortion measure stored.

In a variant to only considering the distortion measure, the decision in step 1406 can be based on combining that distortion measure with an encoding cost corresponding to the cost to encode the AU identifier T_{p,n} (or AU size), the reconstruction offset θ and the block coefficient I, within the bitstream.

For example, a mean-like Lagrangian cost computation may be used.

In case the distortion measure obtained at step 1405 is better, it is recorded together with the corresponding reconstruction parameter pair (θ, i) and the current AU T_{p,n}, at step 1407, in replacement of the values previously stored. It is then determined whether the current AU is the last available one at step 1408 before possibly selecting a next AU as step 1409.

In case the distortion measure obtained at step 1405 is not better, the process goes directly to step 1408.

When all the available AUs have been processed through the loop 1403-1409, the memory stores the best distortion measure for all those AUs, together with its corresponding reconstruction parameter pair (θ, i) and AU unique identifier T_{p,n},

The stored “best” reconstruction parameter pair (θ, i) and AU unique identifier T_{p,n} are then transmitted to the decoder at step 1410, for example by encoding those values into the bitstream dedicated to the decoder.

Encoding those values may be advantageously performed. First, given the partition p and the corresponding encoding parameters (CTB, PU, TU, etc.), the number N1 of available AUs is known, enabling use of a specific entropy encoding of the value T_{p,n} based on the number N1 of available AUs: n1 bits may be used where 2ⁿ¹ is the lowest power of two above N1. The decoder performing the same partitioning, may then also determine n1 and correctly decode T_{p,n}.

Similarly, since T_{p,n} is transmitted to the decoder, the number N2 of possible reconstruction offsets and the number N3 of possible block coefficients are known and can be used to entropy encode the “best” reconstruction parameter pair (θ, i) to transmit in the bitstream.

This process is performed for each partition p that occurs in the first image as represented through the loop 1411-1412-1401. When each partition has been processed, the process ends at step 1413.

At the end of the process, the bitstream includes several tuples {T_{p,n}, θ, i} corresponding to the “best” AU, reconstruction offset and block coefficient, for each defined partition p.

According to various embodiments, those tuples may correspond to a variable number of “second” reconstructions of the first image:
there may be as many “second” reconstructions as tuples, each “second” reconstruction applying the reconstruction parameters only to the blocks of the corresponding partition p, or to all the blocks of the image;
there may be only one “second” reconstruction for all the tuples, in which case a block of a given partition is reconstructed applying only the tuple corresponding to that partition. In other words, two blocks corresponding to two different partitions are reconstructed using their respective obtained reconstruction offset, block coefficient and AU;
there may also be several “second” reconstructions combining, each, one or several tuples of reconstruction parameters applied to the blocks of their respective partition.

As mentioned above, the number of available AUs may be artificially reduced.

A particular case occurs when a single fixed AU is defined for a given partition. In such a case, at the encoder side, the above steps 1403, 1404, 1408 and 1409 may be disregarded since they are useless. Furthermore, there is no need to use and transmit the value T_{p,n}.

Turning now to the corresponding decoding process, it is assumed that the encoded first image has been decoded and reconstructed into the “conventional” reconstruction.

The encoding parameters, such as CTB, PU and TU values, are known by the decoder (retrieved from the decoding). The latter can then perform a partitioning of the first image similar to that performed by the encoder when encoding the first image.

With reference to FIG. 15, the decoding then comprises selecting the first partition p=0, at step 1500.

Similarly to the encoding process, only the partitions that occur in the encoded first image are successively selected (see steps 1501 and 1511 similar to steps 1401 and 1412). In particular, the decoder successively considers those partitions in the same order as the encoder (to enable the decoder to correctly decode T_{p,n} which depends on the partition considered).

For a current partition p that occurs in the first image, the value of T_{p,n} is decoded from the bitstream at step 1502. The decoder knows the Analysis Unit that will be used for the “second” reconstruction.

Based on this knowledge of the AU, the decoder determines various AU parameters at step 1503, in particular its size, but also the ranges of possible reconstruction parameters.

Based on those ranges (from which derives the entropy encoding), the actual reconstruction parameters (θ, i) are decoded from the bitstream at step 1504.

At step 1505, the AU-sized corrective residual block B^{θ,i} is computed, using the obtained values, namely θ, i and AU size.

The decoder then reconstructs the portion of the first image corresponding to the current partition p, using that corrective residual block:
the first AU-sized block of the current partition p is selected from the conventional reconstruction at step 1506: Bₖ (I_{Conv}^{REC}). This is the current block;
the AU-sized corrective residual block B^{θ,i} is added to the current block Bₖ (I_{Conv}^{REC}) at step 1507 to obtain the collocated AU-sized block of the second reconstruction:

Bₖ(I_{θ,i}^{REC})=Bₖ(I_{Conv}^{REC})+B^{θ,i};
then it is checked whether or not the current block is the last block in the current partition p at step 1508. If not, a next available AU-sized block of the current partition p is selected from the conventional reconstruction as the current block, at step 1509 before going back to step 1507.

When the whole portion of the first image corresponding to the current partition p has been reconstructed for the “second” reconstruction, the decoder verifies whether or not the current partition p is the last one at step 1510.

If not, a next partition is selected at step 1511 before going back to step 1501 for reconstructing the portion of the first image corresponding to that new current partition.

Otherwise, the process ends at step 1512.

In this example, each first image portion corresponding to a partition is reconstructed according to the reconstruction parameters associated with that partition. The resulting grouping of reconstructed portions is the “second” reconstruction.

As mentioned above, in a variant, each tuple {T_{p,n}, θ, i} may be used to generate a corresponding second reconstruction.

Such a second reconstruction, which is a reconstructed second reference image, is placed into the list 518/718 of second reconstructions of the decoder, enabling the latter to continue with normal decoding.

In the particular case where a single fixed AU is defined for a given partition, no T_{p,n} value needs to be decoded in such a way that step 1502 may be disregarded. Furthermore, step 1503 is then implicit since the decoder and encoder share the same hardcoding.

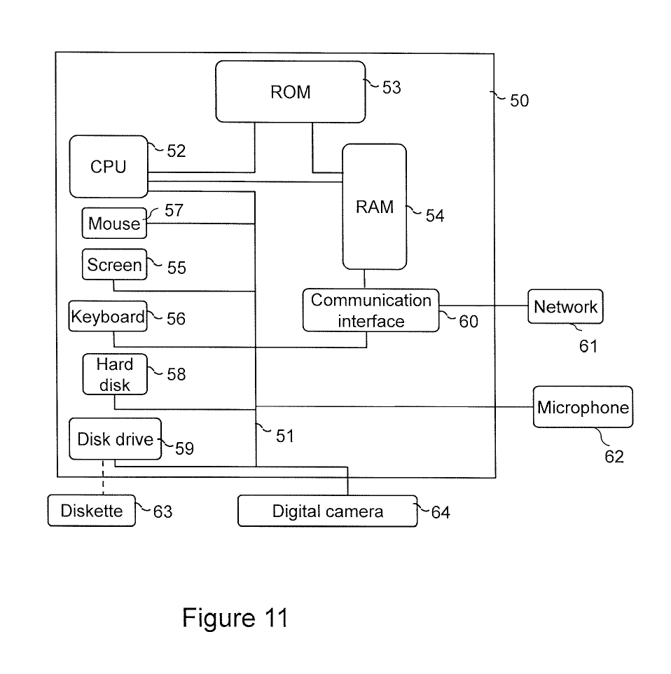

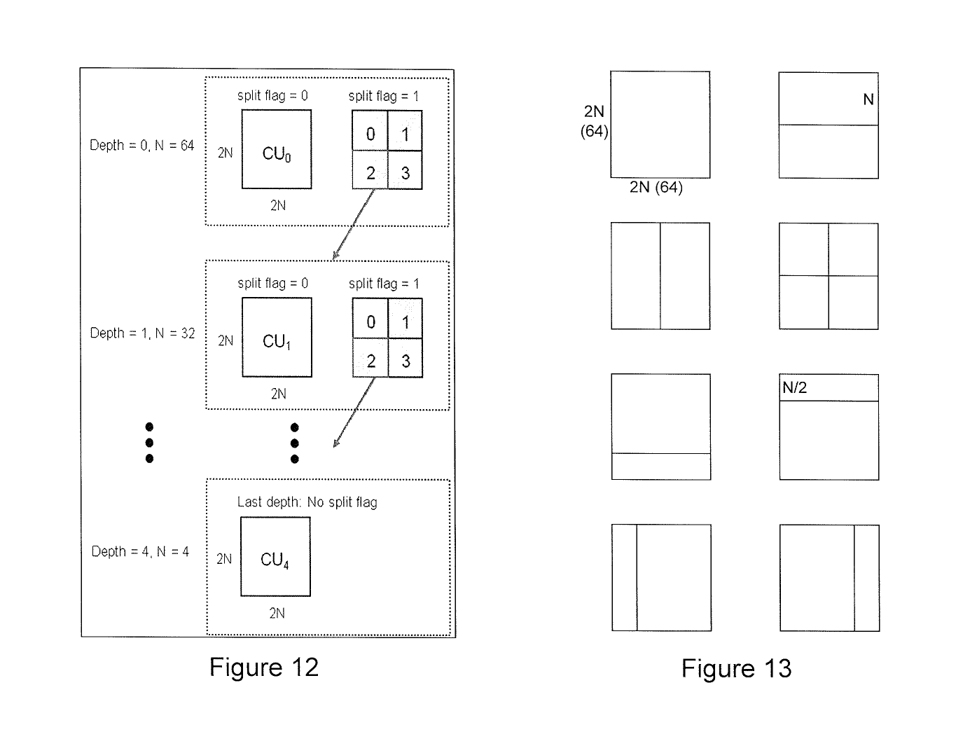

With reference now to FIG. 11, a particular hardware configuration of a device for coding or decoding a video sequence able to implement one of the methods according to the invention is now described by way of example.

A device implementing the invention is for example a microcomputer 50, a workstation, a personal assistant, or a mobile telephone connected to various peripherals. According to yet another embodiment of the invention, the device is in the form of a photographic apparatus provided with a communication interface for allowing connection to a network.

The peripherals connected to the device comprise for example a digital camera 64, or a scanner or any other image acquisition or storage means, connected to an input/output card (not shown) and supplying to the device according to the invention multimedia data, for example of the video sequence type.

The device 50 comprises a communication bus 51 to which there are connected:
a central processing unit CPU 52 taking for example the form of a microprocessor;
a read only memory 53 in which may be contained the programs whose execution enables the methods according to the invention. It may be a flash memory or EEPROM;
a random access memory 54, which, after powering up of the device 50, contains the executable code of the programs of the invention necessary for the implementation of the invention. As this memory 54 is of random access type (RAM), it provides fast accesses compared to the read only memory 53. This RAM memory 54 stores in particular the various images and the various blocks of pixels as the processing is carried out (transform, quantization, storage of the reference images) on the video sequences;
a screen 55 for displaying data, in particular video and/or serving as a graphical interface with the user, who may thus interact with the programs according to the invention, using a keyboard 56 or any other means such as a pointing device, for example a mouse 57 or an optical stylus;
a hard disk 58 or a storage memory, such as a memory of compact flash type, able to contain the programs of the invention as well as data used or produced on implementation of the invention;
an optional diskette drive 59, or another reader for a removable data carrier, adapted to receive a diskette 63 and to read/write thereon data processed or to process in accordance with the invention; and
a communication interface 60 connected to the telecommunications network 61, the interface 60 being adapted to transmit and receive data.

In the case of audio data, the device 50 is preferably equipped with an input/output card (not shown) which is connected to a microphone 62.

The communication bus 51 permits communication and interoperability between the different elements included in the device 50 or connected to it. The representation of the bus 51 is non-limiting and, in particular, the central processing unit 52 unit may communicate instructions to any element of the device 50 directly or by means of another element of the device 50.

The diskettes 63 can be replaced by any information carrier such as a compact disc (CD-ROM) rewritable or not, a ZIP disk or a memory card. Generally, an information storage means, which can be read by a micro-computer or microprocessor, integrated or not into the device for processing a video sequence, and which may possibly be removable, is adapted to store one or more programs whose execution permits the implementation of the method according to the invention.

The executable code enabling the coding device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 58) before being executed.

The central processing unit 52 controls and directs the execution of the instructions or portions of software code of the program or programs of the invention, the instructions or portions of software code being stored in one of the aforementioned storage means. On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

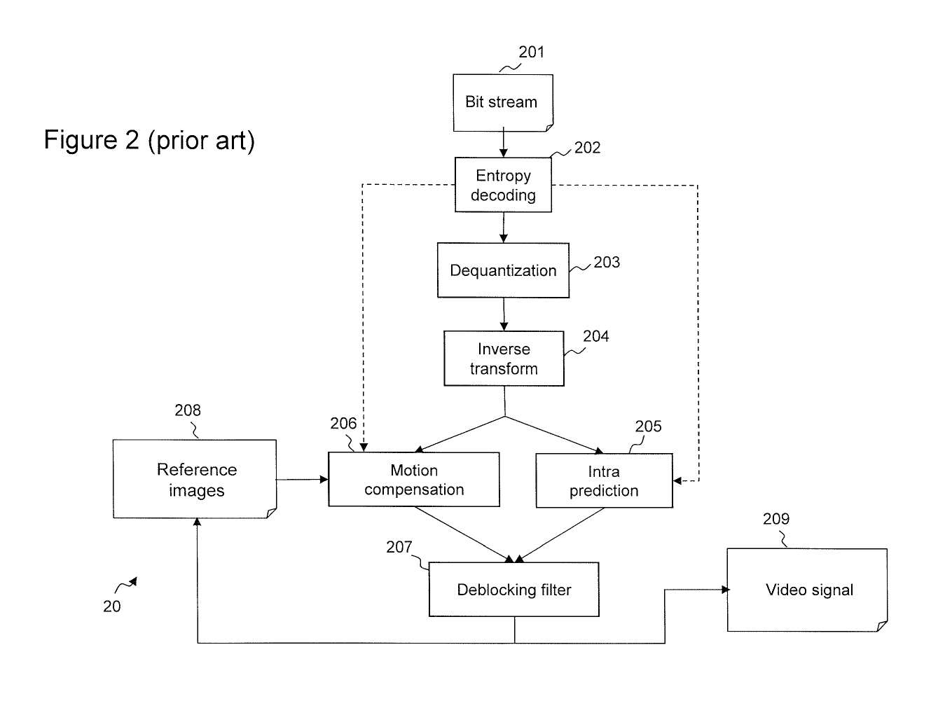

The device described here and, particularly, the central processing unit 52, may implement all or part of the processing operations described in relation with FIGS. 1 to 10, 14 and 15, to implement the methods of the present invention and constitute the devices of the present invention.

The above examples are merely embodiments of the invention, which is not limited thereby.

In particular, mechanisms for interpolating the reference images can also be used during motion compensation and estimation operations, in order to improve the quality of the temporal prediction.

Such an interpolation may result from the mechanisms supported by the H.264 standard in order to obtain motion vectors with a precision of less than 1 pixel, for example ½ pixel, ¼ pixel or even ⅛ pixel according to the interpolation used.

1. A method for encoding a video sequence comprising a succession of images made of data blocks, the method comprising:
encoding a first image into an encoded first image;
obtaining a second reconstruction offset that is different from a first reconstruction offset;
generating first and second reconstructions of the same encoded first image by applying respectively the first reconstruction offset and the second different reconstruction offset to the same block coefficient of at least one block; and
encoding a second image using temporal prediction in which a reference image is selected from a set of reference images that includes the first and second reconstructions;
wherein the obtaining of the second different reconstruction offset comprises:
determining a subset of data blocks of the first image, based on the encoding of the first image;
for each offset from a set of reconstruction offsets, estimating a distortion measure between the blocks of the first reconstruction that are collocated with the determined subset and the blocks of an image reconstruction of the encoded first image using said offset that are collocated with the determined subset; and
based on the estimated distortion measures, selecting one of the reconstruction offsets as the second different reconstruction offset for generating the second reconstruction.

2. The encoding method of claim 1, further comprising, based on encoding parameters used for the encoding of the first image, defining partitions of data blocks; and
selecting, as the determined subset of data blocks, the blocks of the first image corresponding to at least one of the defined partitions.

3. The encoding method of claim 2, wherein defining partitions is based on at least one encoding parameter chosen from the group comprising:
the size or depth of coded tree blocks with which the data blocks of the first image are associated, a coded tree block grouping all data blocks of a square-shaped region of the first image when they share the same encoding parameters;
the type of prediction units applied to the data blocks when encoding the first image with prediction;
the size of the transform units applied to the data blocks when encoding the first image with transform;
the coding mode applied to the data blocks when encoding the first image.

4. The encoding method of claim 2, further comprising dividing the determined subset corresponding to the selected partition into analysis units of the same size, the analysis units being the blocks based on which the distortion measure is estimated.

5. The encoding method of claim 4, further comprising determining the set of reconstruction offsets based on the size of the analysis units.

6. The encoding method of claim 5, further comprising determining a set of block coefficients based on the size of the analysis units to define a set of reconstruction offset and block coefficient pairs;
wherein each pair from the defined set of reconstruction offset and block coefficient pairs is considered when estimating the distortion measures, and the obtaining of the second different reconstruction offset comprises selecting one of the reconstruction offset and block coefficient pairs based on the estimated distortion measures, to obtain a second different reconstruction offset and the corresponding block coefficient to which the obtained second different reconstruction offset is applied.

7. The encoding method of claim 6, wherein the block coefficient of each pair considered when estimating a distortion measure is the mean value coefficient of the data blocks.

8. The encoding method of claim 4, further comprising successively considering several sizes of analysis units to select the analysis unit size, the reconstruction offset, and possibly the block coefficient, that provide the best estimated distortion measure, for generating the second reconstruction.

9. The encoding method of claim 8, wherein the number of analysis unit sizes to successively consider depends on the encoding parameters defining the selected partition.

10. The encoding method of claim 8, wherein selecting the analysis unit size, the reconstruction offset, and possibly the block coefficient for generating the second reconstruction is further based on an encoding cost to encode the analysis unit size, the reconstruction offset, and the possible block coefficient.

11. The encoding method of claim 2, further comprising determining whether or not the encoded first image comprises blocks corresponding to a defined partition before selecting that partition to define the determined subset of data blocks.

12. The encoding method of claim 2, further comprising successively considering a plurality of determined subsets of data blocks corresponding to a plurality of said defined partitions to obtain a corresponding plurality of reconstruction offsets, and possibly block coefficients and analysis unit sizes, for generating the second reconstruction of the first image;
wherein generating the second reconstruction combines reconstructed blocks of the first image, two blocks corresponding to two different partitions being reconstructed using their respective obtained reconstruction offset, and possibly block coefficient and analysis unit size.

13. The encoding method of claim 1, wherein the estimating of a distortion measure comprises comparing:
an error measure between respective data blocks of the first reconstruction and of the first image before encoding that are collocated with a block of the determined subset,
with an error measure between the corresponding data blocks of the image reconstruction and of the first image before encoding that are collocated with said block of the determined subset.

14. The encoding method of claim 1, wherein, during the distortion measure estimation, a block of an image reconstruction of the encoded first image using said offset is obtained from the collocated block of the first reconstruction by adding to it a corrective residual block obtained by inverse quantizing a block of coefficients all equal to zero in which a block coefficient with zero value has been modified by adding the said offset.

15. The encoding method of claim 1, wherein the generating of the second reconstruction comprises:
obtaining a corrective residual block by inverse quantizing a block of coefficients all equal to zero, in which a block coefficient with zero value has been modified by adding the obtained second different reconstruction offset; and
adding the obtained corrective residual block to each data block of the first reconstruction that is collocated with a block of the determined subset, so as to obtain the second reconstruction.

16. A method for decoding a bitstream representing an encoded video sequence comprising a succession of images made of data blocks, the method comprising:
obtaining encoding parameters associated with an encoded first image;
based on the encoding parameters, defining partitions of data blocks;
selecting a partition so as to decode, from the bitstream, an associated analysis unit size and an associated second reconstruction offset that is different from a first reconstruction offset;
generating first and second reconstructions of the same encoded first image by applying respectively the first reconstruction offset and the second different reconstruction offset to the same block coefficient of analysis-unit-sized blocks of the selected partition; and
decoding a second image using temporal prediction in which a reference image is selected from a set of reference images that includes the first and second reconstructions.

17. The decoding method of claim 16, wherein each defined partition is successively selected to decode associated analysis unit sizes and second reconstruction offsets; and
wherein generating the second reconstruction comprises reconstructing the analysis-unit-sized blocks corresponding to each partition using the decoded second reconstruction offset associated with that partition

18. The decoding method of claim 16, wherein the decoding of the second reconstruction offset associated with a partition depends on its decoded associated analysis unit size.

19. A device for encoding a video sequence comprising a succession of images made of data blocks, comprising:
encoding means for encoding a first image into an encoded first image;
means for obtaining a second reconstruction offset that is different from a first reconstruction offset;
generation means for generating first and second reconstructions of the same encoded first image by applying respectively the first reconstruction offset and the second different reconstruction offset to the same block coefficient of at least one block; and
encoding means for encoding a second image using temporal prediction in which a reference image is selected from a set of reference images that includes the first and second reconstructions;
wherein the means for obtaining the second different reconstruction offset are configured to:
determine a subset of data blocks of the first image, based on the encoding of the first image;
for each offset from a set of reconstruction offsets, estimate a distortion measure between the blocks of the first reconstruction that are collocated with the determined subset and the blocks of an image reconstruction of the encoded first image using said offset that are collocated with the determined subset; and
based on the estimated distortion measures, select one of the reconstruction offsets as the second different reconstruction offset for generating the second reconstruction.

20. A computer-readable medium storing a program which, when executed by a processor or computer system in an apparatus for encoding a video sequence comprising a succession of images made of data blocks, causes the apparatus to:
encode a first image into an encoded first image;
obtain a second reconstruction offset that is different from a first reconstruction offset;
generate first and second reconstructions of the same encoded first image by applying respectively the first reconstruction offset and the second different reconstruction offset to the same block coefficient of at least one block; and
encode a second image using temporal prediction in which a reference image is selected from a set of reference images that includes the first and second reconstructions;
wherein the obtaining of the second different reconstruction offset causes the apparatus to:
determine a subset of data blocks of the first image, based on the encoding of the first image;
for each offset from a set of reconstruction offsets, estimate a distortion measure between the blocks of the first reconstruction that are collocated with the determined subset and the blocks of an image reconstruction of the encoded first image using said offset that are collocated with the determined subset; and
based on the estimated distortion measures, select one of the reconstruction offsets as the second different reconstruction offset for generating the second reconstruction.

21. A computer-readable medium storing a program which, when executed by a processor or computer system in an apparatus for decoding a bitstream representing an encoded video sequence comprising a succession of images made of data blocks, causes the apparatus to:
obtain encoding parameters associated with an encoded first image;
based on the encoding parameters, define partitions of data blocks;
select a partition so as to decode, from the bitstream, an associated analysis unit size and an associated second reconstruction offset that is different from a first reconstruction offset;
generate first and second reconstructions of the same encoded first image by applying respectively the first reconstruction offset and the second different reconstruction offset to the same block coefficient of analysis-unit-sized blocks of the selected partition; and
decode a second image using temporal prediction in which a reference image is selected from a set of reference images that includes the first and second reconstructions.
